SEQUENCE LISTING (58 sequences)

SEQ ID NO: 1 - protein, 323 aa, Artificial Sequence
  NCBI influenza virus sequence
ENGTCYPGEFIDYEELREQLSSISSFEKFEIFPKASSWPNHETTKGVTAACSYSGASSFYRNLLWITKKGTSYPKLSKSYTNNKGKEVLVLWGVHHPPSVSEQQSLYQNADAYVSVGSSKYNRRFAPEIAARPEVRGQAGRMNYYWTLLDQGDTITFEATGNLIAPWYAFALNKGSDSGIITSDAPVHNCDTRCQTPHGALNSSLPFQNVHPITIGECPKYVKSTKLRMATGLRNVPSIQSRGLFGAIAGFIEGGWTGMIDGWYGYHHQNEQGSGYAADQKSTQNAIDGITSKVNSVIEKMNTQFTAVGKEFNNLERRIENLN

SEQ ID NO: 2 - protein, 323 aa, Artificial Sequence
  NCBI influenza virus sequence
ENGTCYPGDFIDYEELREQLSSVSSFEKFEIFPKTSSWPNHETTKGVTAACSYAGASSFYRNLLWLTKKGSSYPKLSKSYVNNKGKEVLVLWGVHHPPTGTDQQSLYQNADAYVSVGSSKYNRRFTPEIAARPKVRDQAGRMNYYWTLLEPGDTITFEATGNLIAPWYAFALNRGSGSGIITSDAPVHDCNTKCQTPHGAINSSLPFQNIHPVTIGECPKYVRSTKLRMATGLRNIPSIQSRGLFGAIAGFIEGGWTGMIDGWYGYHHQNEQGSGYAADQKSTQNAIDGITNKVNSVIEKMNTQFTAVGKEFNNLERRIENLN

SEQ ID NO: 3 - protein, 322 aa, Artificial Sequence
  NCBI influenza virus sequence
ENGTCYPGYFADYEELREQLSSVSSFERFEIFPKESSWPNHTVTGVSASCSHNGKSSFYRNLLWLTGKNGLYPNLSKSYVNNKEKEVLVLWGVHHPPNIGDQRALYHTENAYVSVVSSHYSRRFTPEIAKRPKVRDQEGRINYYWTLLEPGDTIIFEANGNLIAPWYAFALSRGFGSGIITSNAPMDECDAKCQTPQGAINSSLPFQNVHPVTIGECPKYVRSAKLRMVTGLRNIPSIQSRGLFGAIAGFIEGGWTGMVDGWYGYHHQNEQGSGYAADQKSTQNAINGITNKVNSVIEKMNTQFTAVGKEFNKLERRMENLN

SEQ ID NO: 4 - protein, 321 aa, Artificial Sequence
  NCBI influenza virus sequence
ANGLCYPGSFNDYEELKHLLTSVTHFEKVKILPRDQWTQHTTTGGSRACAVSGNPSFFRNMVWLTEKGSNYPIAKRSYNNTSGKQMLVIWGIHHPNDDTEQRTLYQNVGTYVSVGTSTLNKRSIPEIATRPKVNGQGGRMEFSWTLLETWDVINFESTGNLIAPEYGFKISKRGSSGIMKTEKTLENCETKCQTPLGAINTTLPFHNIHPLTIGECPKYVKSDRLVLATGLRNVPQIESRGLFGAIAGFIEGGWQGMVDGWYGYHHSNDQGSGYAADKESTQKAIDGITNKVNSVIEKMNTQFEAVGKEFNNLERRLENLN

SEQ ID NO: 5 - protein, 321 aa, Artificial Sequence
  NCBI influenza virus sequence
RDGLCYPGSFNDYEELKHLLSSVKHFEKVKILPKDRWTQHTTTGGSRACAVSGNPSFFRNMVWLTEKGSNYPVAKGSYNNTSGEQMLIIWGVHHPNDEKEQRTLYQNVGTYVSVGTSTLNKRSTPDIATRPKVNGLGSRMEFSWTLLDMWDTINFESTGNLIAPEYGFKISKRGSSGIMKTEGTLENCETKCQTPLGAINTTLPFHNVHPLTIGECPKYVKSEKLVLATGLRNVPQIESRGLFGAIAGFIEGGWQGMIDGWYGYHHSNDQGSGYAADKESTQKAFDGITNKVNSVIEKMNTQFEAVGKEFSNLERRLENLN

SEQ ID NO: 6 - protein, 316 aa, Artificial Sequence
  NCBI influenza virus sequence
FSNCYPYDIPDYASLRSLVASSGTLEFITEGFTWTGVTQNGGSSACKRGPANGFFSRLNWLTKSESAYPVLNVTMPNNDNFDKLYIWGVHHPSTNQEQTDLYVQASGRVTVSTRRSQQTIIPNIGSRPWVRGQPGRISIYWTIVKPGDVLVINSNGNLIAPRGYFKMRTGKSSIMRSDAPIDTCISECITPNGSIPNDKPFQNVNKITYGACPKYVKNTLKLATGMRNVPGKQTRGLFGAIAGFIENGWEGMIDGWYGFRHQNSEGTGQAADLKSTQAAIDQINRKLNRVIEKTNEKFHQIEKEFSEVEGRIQDLE

SEQ ID NO: 7 - protein, 315 aa, Artificial Sequence
  NCBI influenza virus sequence
FSNCYPYDVPDYASLRSLVASSGTLEFITEGFTWTGVTQNGGSNACKRGPGSGFFSRLNWLTKSGSTYPVLNVTMPNNDNFDKLYIWGIHHPSTNQEQTSLYVQASGRVTVSTRRSQQTIIPNIGSRPWVRGLSSRISTYWTIVKPGDVLVINSNGNLIAPRGYFKMRTGKSSIMRSDAPIDTCISECITPNGSIPNKPFQNVNKITYGACPKYVKQNTLKLATGMRNVPEKQTRGLFGAIAGFIENGWEGMIDGWYGFRHQNSEGTGQAALKSTQAATDQINGKLNRVIEKTNEKFHQIEKEFSEVEGRIQDLE

SEQ ID NO: 8 - protein, 316 aa, Artificial Sequence
  NCBI influenza virus sequence
YSNCYPYDVPDYASLRSLVASSGTLEFNNESFNWAGVTQNGTSSACKRRSNKSFFSRLNWLTHLKYKYPALNVIMPNNEKFDKLYIWGVHHPVTDSDQISLYAQASGRITVSTKRSQQTVIPNIGYRPRVRDISSRISTYWTIVKPGDILLINSTGNLIAPRGYFKIRSGKSSIMRSDAPIGKCNSECITPNGSIPNDKPFQNVNRITYGACPRYVKQNTLKLATGMRNVPEKQTRGIFGAIAGFIENGWEGMVDGWYGFRHQNSEGTGQAADLKSTQAAINQINGKLRLIGKTNEKFHQIEKEFSEVEGRIQDLE

SEQ ID NO: 9 - protein, 319 aa, Artificial Sequence
  NCBI influenza virus sequence
VDTCYPFDVPDYQSLRSILANNGKFEFIAEEFQWNTVKQNGKSGACKRANVNDFFNRLNWLTKSNGDAYPLQNLTKVNNGDYARLYIWGVHHPSTDTEQTDLYKNNPGRVTVSTKTSQTSVVPNIGSRPWVRGQSGRISFYWTIVDPGDIIVFNTIGNLIAPRCHYKLNSQKKSTILNTAVPIGSCVSKCHTDRGSITTTKPFQNISRISIGDCPKYVKQGSLKLATGMRNIPEKATRGLFGAIAGFIENGWQGLIDGWYGFRHQNAEGTGTAADLKSTQAAIDQINGKLRNLIEKTNEKYHQIEKEFEQVEGRIQDLE

SEQ ID NO: 10 - protein, 324 aa, Artificial Sequence
  NCBI influenza virus sequence
VNDLCYPGDFNYEELKHLLSRINHFEKIQIIPKSSWSSHEASLGVSSACPYQGKSSFFRNVVWLIKKNSTYPTIKRSYNNTNQEDLLVLWGTHHPNDAAEQTKLYQNPTTYISVGTSTLNQRLVPRIATRSKVNGQSGRHEFFWTILKPNDINFESNGNFIAPEYAYKIVKKGDSTIMKSELEYGNCNTKCQTMGAINSSMPFHNIHPLTIGECPKYVKSNRLVLATGLRNSPQRERRRRKKRGLFGAIAGFIEGGWQGMVDGWYGYHHSNEQGSGYAADKESTQKAIDGVTNKVNSIIDKMNTQFEAVGREFNWLERRIENLN

SEQ ID NO: 11 - protein, 326 aa, Artificial Sequence
  NCBI influenza virus sequence
ANDLCYPGDFNDYEELKHLLSRINHFEKIQIIPKNSWSSHEASLGVSSACPYQGKSSFFRNVVWLIKKNNAYPTIKRSYNNTNQEDLLVLWGIHHPNDAAEQTRLYQNPTTYISVGTSTLNQRLVPKIATRSKVNGQNGRMEFFWTILKPNDAINFESNGNFIAPEYAYKIVKKGDSAIMKSELEYGNCNTKCQTPMGAINSSMPFHNIHPLTIGECPKYVKNSRLVLATGLRNSPQRERRRKKRGLFGAIAGFIEGGWQGMVDGWYGYHHSNEQGSGYAADKESTQKAIDGVTNKVNSIIDKMNTQFEAVGREFNNLERRIENLN

SEQ ID NO: 12 - protein, 325 aa, Artificial Sequence
  NCBI influenza virus sequence
QNGICYPGTLNEIEELKALIGSGERIERFEMFPKSTWSGVNTNNGVTRACPDNSGSSFYRNLLWITKTNSAAYPVIKGTYNNTGNQPILYFWGVHHPPDTNAQNNLYGSGDRYVRMGTESMNFAKGPEISARPVVNGQRGRIDYYWSVLKPGETLNVESNGNLIAPWYAYKFVSTNSKGAVFKSNLPIENCDATCQTTIAGVLRTNKTFQNVSPLWIGKCPKYVKSESLRLATGLRNVPQIATRGLFGAIAGFIEGGWTGLVDGWYGYHHENSQGSGYAADREATQKAIDGITNKVNSIIDKMNTQFEAVDHEFSNLERRIDNMN

SEQ ID NO: 13 - protein, 319 aa, Artificial Sequence
  NCBI influenza virus sequence
SDVCYPGKFVNEEALRQILRESGGINKETMGFTYSGIRTNGATSTCRRSGSSFYAEMKWLLSNTDNAAFPQMTKSYKNTRKDPALIIWGIHHSGSTTEQTKLYGSGNKLITVESSNYQQSFVPSPGARPKVDGQSGRIDFHWLMLNPNDTITFSFNGAFIAPDRASFLRGKSMGIQSGVQVDDNCEGDCYHSGGTIISNLPFQNINSRAVGKCPRYVKQESLMLATGMKNVPEIPKGRGLFGAIAGFIENGWEGLIDGWYGFRHQNAQGEGTAADYKSTQSAIDQITGKLNRLIEKTNQQFELIDNEFTEVEKQIGNVI

SEQ ID NO: 14 - protein, 325 aa, Artificial Sequence
  NCBI influenza virus sequence
PEGMCYPGSVENLEELRFVFSSAASYKRIRLFDYSRWNVTRSGTSKACNASTGGQSFYRSINWLTKKKPDTYDFNEGAYVNNEDGDIIFLWGIHHPPDTKEQTTLYKNANTLSSVTTNTINRSFQPNIGPRPLVRGQQGRMDYYWGILKRGETLKIRTNGNLIAPEFGYLLKGESYGRIIQNEDIPIGNCNTKCQTYAGAINSSKPFQNASHRHYMGECPKYVKKASLRLAVGLRNTPSVEPRGLFGAIAGFIEGGWSGMIDGWYGFHHSNESEGTGMAADQKSTQEAIDKITNKVNNIVDKMNREFEVVNHEFSEVEKRINMIN

SEQ ID NO: 15 - protein, 316 aa, Artificial Sequence
  NCBI influenza virus sequence
VNGTCYPGNVENLEELRTLFSSASSYQRIQIFPDTIWNVTVTGTSKACSGSFYRSMRWLTQKSGSYPVQDAQYTNNREKSILFVWGIHHPPTDTAWTNLYINTDTTTSVTTEDLNRIFKPVIGPRPLVNGLQGRINYYWSVLKPGQTLRVRSNGNLIAPWYGHVLSGGSHGRILKTDLNSGNCVVQCQTEKGGLNSTLPFHNISKYAFGICPKYVRVKSLKLAVGLRNVPARSNRGLFGAIAGFIEGGWPGLVAGWYGFQHSNDQGVGMAADRDSTQRAIDKITSKVNNIVDKMNKQYEIIDHEFSEVETRLNMIN

SEQ ID NO: 16 - protein, 321 aa, Artificial Sequence
  NCBI influenza virus sequence
IAYCYPGATVNEEALRQKIMESGGIDKISTGFTYGSSINSAGTTRSCMRSGGNSFYAELKWLVSKNKGQNFPQTANTYRNTDSAEHLIIWGIHHPSSTQEKNDLYGTQSLSISVGSSTYQNNFVPVVGARPQVNGQSGRIDFHWTMVQPGDNITFSHNGGLIAPSRVSKLKGRGLGIQSGASVDNDCESKCFWKGGSINTKLPFQNLSPRTVGQCPKYVNKKSLLLATGMRNVPEVVQGRGLFGAIAGFIENGWEGMVDGWYGFRHQNAQGTGQAADYKSTQAAIDQITGKLNRLIEKTNTEFESIESEFSEIEHQIGNVI

SEQ ID NO: 17 - protein, 321 aa, Artificial Sequence
  NCBI influenza virus sequence
TNGICYPTLENEEELRLKFSGVLEFSKFEAFTSNGWGAVNSGAGVTAACKFGSSNSFFRNMIWLIHQSGTYPVIRRTFNNTKGRDVLVVWGVHHPATLKEHQDLYKKDSSYVAVDSESYNRRFTPEISTRPKVNGQAGRMTFYWTIVKPGEAITESNGAFLAPRYAFELVSLGNGKLFRSDLNIESCSTKCQSEIGGINTNRSFHNVHRNTIGDCPKYVNVKSLKLATLGLRNVPAIATRGLFGAIAGFIEGGWPGLINGWYGFQHRNEEGTGIAADKESTQKAIDQITSKVNNIVDRMNTNFESVQHEFSEIEERINQLS

SEQ ID NO: 18 - protein, 320 aa, Artificial Sequence
  NCBI influenza virus sequence
MEGVCYPGSIENQEELRSLFSSIKKYERVKMFDFTKWNVTYTGTSRACNNTSNRGSFYRSMRWLTLKSGQFPVQTDEYKNTRDSDILFTWAIHHPPTSAEQVQLYKNPDTLSSVTTDEINRSFKPNIGPRPLVRGQQGRMDYYWAVLKPGQTKIGTNGNLIAPEYGHLITGKSHGRILKNNLPVGQCVTECQLNEGVMNTSKPFQNTSKHYIGKCPKYIPSGSLKLAIGLRNVPQVQNRGLFGAIAGFIEGGWPGLVAGWYGFQHQNAEGTGMAADRDSTQKAIDNMQNKLNNVIDKMNKQFEVVNHEFSEVESRINMIN

SEQ ID NO: 19 - protein, 318 aa, Artificial Sequence
  NCBI influenza virus sequence
PHGLCYPGELNNNGELRHLFSGIRSFSRTELIPPTSWGEVLDGATSARDDKGTNSFYRNLVWFVKKNNRYPVISKTNNTTGRVLVLWGIHHPVSVEETKTLYVNSDPYTLVSTKSWSEKYKLETGVRPGYNGQRSWMKIYWSLLHPGEMITFESNGGLLAPRYGYIIEEYGKGRIFQSRIRMSKCNTKCQTSVGGINTNRTFQNIDKNALGDCPKYIKSGQLKLATGLRNVPAIDNRGLLGAIAGFIEGGWPGLINGWYGFQHQNEQGTGIAADKESTQKAIDQITTKINNIIDKMNGNYDSIRGEFNQVEKRINMLA

SEQ ID NO: 20 - protein, 317 aa, Artificial Sequence
  NCBI influenza virus sequence
VDTCYPFDVPDYQSLRSILASSGSLEFIAEQFTWNGVKVDGSSSACLRGGRNSFFSRLNWLTKETNGNTGPINVTKENTGSYVRLYLWGVHHPSSDNEQTDLYKVATGRVTVSTRSDQISIVPNIGSRPRVRNQSGRISIYWTLVNPGDSIIFNSIGNLIAPRGHYKISKSTKSTVLKSDKRIGSCTSPCLTDKGSIQSDKPFQNVSRIAIGNCPKYVKQGSLMLATGMRNIPGKQAKGLFGAIAGFIENGWQGLIDWYGFRHQNAEGTGTAADLKSTQAAIDQINKLNRLIEKTNEKYHQIEKEFEQVEGRIQDLE

SEQ ID NO: 21 - protein, 327 aa, Artificial Sequence
  NCBI influenza virus sequence
SDICYPGKFTNEEALRQIIRESGGIDKEPMGFRYSGIKTDGATSACKRTVSSFYSEMKWLLSSKANQVFPQLQTYRNNRKEPALIVWGVHHSSSLDEQNKLYGAGNKLITVGSSKYQQSFSPSPDRPKVNGQAGRIDFHWMLLDPGDTVTFTFNGAFIAPDRATFLRSNAPSGVEYNGKSLGIQSDAQIDESCEGECFYSGGTINSPLPFQNIDSWAVGRCPRYVKQSSLPLALGMKNVPEKIHTRGLFGAIAGFIENGWEGLIDGWYGFRHQNAQGQGTAADYKSTQAAIDQITGKLNRLIEKTNTQFELIDNEFTEVEQQIGNVI

SEQ ID NO: 22 - protein, 320 aa, Artificial Sequence
  NCBI influenza virus sequence
PNKLCFRGELDNNGELRHLFSGVNSFSRTELISPNKWGDILDGVTASCRDNGASSFYRNLVWIVKNKNGKYPVIKGDYNNTTGRDVLVLWGIHHPDTETTAINLYASKNPYTLVSTKEWSKRYELEIGTRIGDGQRSWMKLYWHLMRPGERIMFESNGGLIAPRYGYIIEKYGTGRIFQSGVRMAKCNTKCQTSLGGINTNKTFQNIERNALGDCPKYIKSGQLKLATGLRNVPSVGERGLFGAIAGFIEGGWPGLINGWYGFQHQNEQGTGIAADKASTQKAIDEITTKINNIIEKMNGNYDSIRGEFNQVEKRINMLA

SEQ ID NO: 23 - protein, 164 aa, Artificial Sequence
  HA glycan binding domain sequence
SYIIETSNSENGTCYPGEFIDYEELREQLSSISSFEKFEIFPKASSWPNHETTKGVTAACSYSGASSFYRNLLWITKKGTSYPKLSKSYTNNKGKEVLVLWGVHHPPSVSEQQSLYQNADAYVSVGSSKYNRRFAPEIAARPEVRGQAGRMNYYWTLLDQGDTI

SEQ ID NO: 24 - protein, 164 aa, Artificial Sequence
  HA glycan binding domain sequence
SYIVETSNSDNGTCYPGDFIDYEELREQLSSVSSFEKFEIFPKTSSWPNHETTRGVTAACPYAGASSFYRNLLWLVKKGNSYPKLSKSYVNNKGKEVLVLWGVHHPPTSTDQQSLYQNADAYVSVGSSKYDRRFTPEIAARPKVRGQAGRMNYYWTLLEPGDTI

SEQ ID NO: 25 - protein, 163 aa, Artificial Sequence
  HA glycan binding domain sequence
SYIVETPNSENGICYPGDFIDYEELREQLSSVSSFERFEIFPKESSWPNHNTNGVTAACSHEGKSSFYRNLLWLTEKEGSYPKLKNSYVNKKGKEVLVLWGIHHPPNSKEQQNLYQNENAYVSVVTSNYNRRFTPEIAERPKVRDQAGRMNYYWTLLKPGDTI

SEQ ID NO: 26 - protein, 164 aa, Artificial Sequence
  HA glycan binding domain sequence
SYIVETSNSENGTCYPGDFIDYEELREQLSSVSSFEKFEIFPKTSSWPNHETTKGVTAACSYAGASSFYRNLLWLTKKGSSYPKLSKSYVNNKGKEVLVLWGVHHPPTGTDQQSLYQNADAYVSVGSSKYNRRFTPEIAARPKVRDQAGRMNYYWTLLEPGDTI

SEQ ID NO: 27 - protein, 164 aa, Artificial Sequence
  HA glycan binding domain sequence
SYIAETPNPENGTCYPGYFADYEELREQLSSVSSFERFEIFPKESSWPNHTVTKGVTTSCSHNGKSSFYRNLLWLTKKNGLYPNVSKSYVNNKEKEVLVLWGVHHPSNIGDQRAIYHTENAYVSVVSSHYSRRFTPEIAKRPKVRDQEGRINYYWTLLEPGDTI

SEQ ID NO: 28 - protein, 164 aa, Artificial Sequence
  HA glycan binding domain sequence
SYIVETSNSENGTCYPGDFIDYEELREQLSSVSSFEKFEIFPKTSSWPNHETTKGVTAACSYAGASSFYRNLLWLTKKGSSYPKLSKSYVNNKGKEVLVLWGVHHPPTGTDQQSLYQNADAYVSVGSSKYNRRFTPEIAARPKVRGQAGRMNYYWTLLEPGDTI

SEQ ID NO: 29 - protein, 158 aa, Artificial Sequence
  HA glycan binding domain sequence
DLFVERSNAFSNCYPYDIPDYASRSLVASSGTLEFITEGFTWTGVTQNGGSSACKRGPANGFFSRLNWLTKSESAYPVLNVTMPNNDNFDKLYIWGVHHPSTNQEQTNLYVQASGRVTVSTRRSQQTIIPNIGSRPWVRGQPGRISIYWTIVKPGDVL

SEQ ID NO: 30 - protein, 159 aa, Artificial Sequence
  HA glycan binding domain sequence
DLFVERSKAFSNCYPYDVPDYASLRSLVASSGTLEFITEGFTWTGVTQNGGSNACKRGPGSGFFSRLNWLTKSGSTYPVLNVTMPNNDNFDKLYIWGIHHPSTNQEQTSLYVQASGRVTVSTRRSQQTIIPNIGSRPWVRGLSSRISIYWTIVKPGDVL

SEQ ID NO: 31 - protein, 157 aa, Artificial Sequence
  HA glycan binding domain sequence
DLFVERSKAYSNCYPYDVPDYASLRSLVASSGTLEFNNESFNWTGVANGTSSSCKRRSIKSFFSRLNWLHLKYRYPALNVTMPNNDKFDKLYIWGVHHPSTDSDQTSLYTQASGRVTVSTKRSQQTVIPNIGSRPWVRGISSRISIYWTIVKPGDLL

SEQ ID NO: 32 - protein, 163 aa, Artificial Sequence
  HA glycan binding domain sequence
SYIVEKDNPVNGLCYPENFNDYEELKHLLSSTNHFEKIRIIPRSSWSNHDASSGVSSACPYNGRSSFFRNVVWLIKKNNAYPTIKRSYNNTNQEDLLILWGIHHPNDAAEQTKLYQNPTTYVSVGTSTLNQRSVPEIATRPKVNGQSGRMEFFWTILKPNDAI

SEQ ID NO: 33 - protein, 163 aa, Artificial Sequence
  HA glycan binding domain sequence
SYIVEKANPVNDLCYPGDFNDYEELKHLLSRINHFEKIQIIPKSSWSSHEASLGVSSACPYQGKSSFFRNVVWLIKKNSTYPTIKRSYNNTNQEDLLVLWGIHHPNDAAEQTKLYQNPTTYISVGTSTLNQRLVPRIATRSKVNGQSGRMEFFWTIIKPNDAI

SEQ ID NO: 34 - protein, 570 aa, Artificial Sequence
  Sequence alignment illustrating conserved subsequences characteristic of H5 HA.
MEKIVLLLAIVSLVKSDQICIGYHANNSTEQVDTIMEKNVTVTHAQDILEKTHNGKLCDLDGVKPLILRDCSVAGWLLGNPMCDEFINVPEWSYIVEKANPANDLYCYPGDFNDYEELKHLLSRINHFEKIQIIPKSSWSDHEASSGVSSACPYQGKSSFFRNVVWLIKKNSAYPTIKKRSYNNTNQEDLLVLWGIHHPNDAAEQTKLYQNPTTYISVGTSTLNQRLVPKIATRSKVNGQSGRMEFFWTILKPNDAINFESNGNFIAPEYAYKIVKKGDSTIMKSELEYGNCNTKCQTPMGAINSSMPFHNIHPLTIGECPKYVKSNRLVLATGLRNSPQRERRRKKRGLFGAIAGFIEGGWQGMVDGWYGYHHSNEQGSGYAADKESTQKAIDGVTNKVNSIIDKMNTQFEAVGREFNNLERRIENLNKKMEDGFLDVWTYNAELLVLMENERTLDFHDSNVKNLYDKVRLQLRDNAKELGNGCFEFYHKCDNECMESVRNGTYDYPQYSEEARLKREEISGVKLESIGTYQILSIYSTVASSLALAIMVAGLSLWMCSNGSLQCRICI

SEQ ID NO: 35 - protein, 570 aa, Artificial Sequence
  Sequence alignment illustrating conserved subsequences characteristic of H5 HA.
MEKIVLLLAIVSLVKSDQICIGYHANNSTEQVDTIMEKNVTVTHAQDILEKTHNGKLCDLDGVKPLILRDCSVAGWLLGNPMCDEFINVPEWSYIVEKASPDNDLYCYPGDFNDYEELKHLLSRINHFEKIQIIPKSSWSNHEASSGVSSACPYHGKSSFFRNVVWLIKKNSAYPTIKKRSYNNTNQEDLLVLWGIHHPNDAAEQTKLYQNPTTYISVGTSTLNQRLVPKIATRSKVNGQSGRMEFFWTILKPNDAINFESNGNFIAPEYAYKIVKKGDSAIMKSELEYGNCNTKCQTPMGAINSSMPFHNIHPLTIGECPKYVKSNRLVLATGLRNTPQREGRRKKRGLFGAIAGFIEGGWQGMVDGWYGYHHSNEQGSGYAADKESTQKAIDGVTNKVNSIIDKMNTQFEAVGREFNKLERRIENLNKKMEDGFLDVWTYNAELLVLMENERTLDFHDSNVKNLYDKVRLQLRDNAKELGNGCFEFYHKCDNECMESVKNGTYDYPQYSEEARLNREEISGVKLESMGTYQILSIYSTVASSLALAIMVAGLSLWMCSNGSLQCRICI

SEQ ID NO: 36 - protein, 558 aa, Artificial Sequence
  Sequence alignment illustrating conserved subsequences characteristic of H5 HA.
MEKIVLLFAIVSLVKSDQICIGYHANNSTEQVDTIMEKNVTVTHAQDILEKTHNGKLCDLDGVKPLILRDCSVAGWLLGNPMCDEFINVPEWSYIVEKANPVNDLYCYPGDFNDYEELKHLLSRINHFEKIQIIPKSSWSSHEASLGVSSACPYQGKSSFFRNVVWLIKKNSTYPTIKKRSYNNTNQEDLLVLWGIHHPNDAAEQTKLYQNPTTYISVGTSTLNQRLVPRIATRSKVNGQSGRMEFFWTILKPNDAINFESNGNFIAPEYAYKIVKKGDSTIMKSELEYGNCNTKCQTPMGAINSSMPFHNIHPLTIGECPKYVKSNRLVLATGLRNSPQRERRRKKRGLFGAIAGFIEGGWQGMVDGWYGYHHSNEQGSGYAADKESTQKAIDGVTNKVNSIIDKMNTQFEAVGREFNNLERRIENLNKKMEDGFLDVWTYNAELLVLMENERTLDFHDSNVKNLYDKVRLQLRDNAKELGNGCFEFYHKCDNECMESVRNGTYDYPQYSEEARLKREEISGVKLESIGIYQILSIYSTVASSLALAIMVAGLSLWM

SEQ ID NO: 37 - protein, 570 aa, Artificial Sequence
  Sequence alignment illustrating conserved subsequences characteristic of H5 HA.
MEKIVLLFAIVSLVKSDQICIGYHANNSTEQVDTIMEKNVTVTHAQDILEKTHNGKLCDLDGVKPLILRDCSVAGWLLGNPMCDEFINVPEWSYIVEKANPVNDLYCYPGDFNDYEELKHLLSRINHFEKIQIIPKSSWSSHEASLGVSSACPYQGKPSFFRNVVWLIKKNSTYPTIKKRSYNNTNIEDLLILWGIHHPNDAAEQTKLYQNSNTYVSVGTSTLNQRSIPEIATRPKVNGQSGRMEFFWTILKPNDAINFESNGNFIAPEYAYKIVKKGDSTIMKSELEYGNCNTKCQTPMGAINSSMPFHNIHPLTIGECPKYVKSNRLVLATGLRNSPQRERRRKKRGLFGAIAGFIEGGWQGMVDGWYGYHHSNKQGSGYAADKESTQKAIDGVTNKVNSIIDKMNTQFEAVGREFNNLERRIENLNKKMEDGFLDVWTYNAELLVLMENERTLDFHDSNVKNLYDKVRLQLRDNAKELGNGCFEFYHKCDNECMESVRNGTYDYPQYSEEARLKREEISGVKLESIGIYQILSIYSTVASSLALAIMVAGLSLWMCSNGSLQCRICI

SEQ ID NO: 38 - protein, 566 aa, Artificial Sequence
  Sequence alignment illustrating conserved subsequences characteristic of H5 HA.
MERIVIALAIISIVKGDQICIGYHANNSTKQVDTIMEKNVTVTHAQDILEKEHNGKLCSLKGVRPLILKDCSVAGWLLGNPMCDEFLNVPEWSYIVEKDNPINGLYCYPGDFNDYEELKHLMSSTNHFEKIQIIPRSSWSNHDASSGVSSACPYNGRSSFFRNVVWLIKKNNAYPTIKKRTYNNTNIEDLLILWGIHHPNDAAEQTKLYQNSNTYVSVGTSTLNQRSIPEIATRPKVNGQSGRMEFFWTILKPNDAISFESNGNFIAPEYAYKIVKKGDSAIMKSELEYGNCDTKCQTPVGAINSSMPFHNVHPLTIGECPKYVKSDKLVLATGLRNVPQRETRGLFGAIAGFIEGGWQGMVDGWYGYHHSNEQGSGYAADKESTQKAIDGITNKVNSIIDKMNTQFETVGKEFNNLERRIENLNKKMEDGFLDVWTYNAELLVLMENERTLDFHDSNVKNLYDKVRLQLRDNAKELGNGCFEFYHKCDNECMESVRNGTYDYPQYSEESRLNREEIDGVKLESMGTYQILSIYSTVASSLALAIMVAGLSFWMCSNGSLQCRICI

SEQ ID NO: 39 - protein, 569 aa, Artificial Sequence
  Sequence alignment illustrating conserved subsequences characteristic of H5 HA.
MEKIVLLLAIVSLVKSDQICIGYHANNSTEQVDTIMEKNVTVTHAQDILEKTHNGKLCDLDGVKPLILKDCSVAGWLLGNPMCDEFINVPEWSYIVEKANPANDLYCYPGIFNDYEELKHLLSRINHFEKIQIIPKSSWSDHEASSGVSSACPYQGKSSFFRNVVWLIKKNSAYPTIKKISYNNTNQEDLLVLWGIHHPNDAAEQTRLYQNPTTYISVGTSTLNQRLVPKIATRSKVNGQSGRMEFFWTILKPNDAVNFESNGNFIAPEYAYKIVKKGDSTIMKSELEYGDCNTKCQTPMGAINSSMPFHNIHPLTIGECPKYVKSNRLVLATGLRNSPQRERRKKRGLFGAIAGFIEGGWQGMVDGWYGYHHSNEQGSGYAADKESTQKAIDGVTNKVNSIIDKMNTQFEAVGREFNNLERRIENLNKKMEDGFLDVWTYNAELLVLMENERTLDFHDSNVKNLYDKVRLQLRDNAKELGNGCFEFYHKCDNECMESVRNGTYDYPQYSEEARLKREEISGVKLESIGTYQILSIYSTVASSLALAIMVAGLSLWMCSNGSLQCRICI

SEQ ID NO: 40 - protein, 566 aa, Artificial Sequence
  Sequence alignment illustrating conserved subsequences characteristic of H5 HA.
VLLLAIVSLVKSDQICIGYHANNSTEQVDTIMEKNVTVTHAQDILEKTHNGKLCDLDGVKPLILRDCSVAGWLLGNPMCDEFLNVPEWSYIVEKINPANDLYCYPGNFNDYEELKHLLSRINHFEKIQIIPKSSWSDHEASSGVSSACPYQGRSSFFRNVVWLIKKDNAYPTIKKRSYNNTNQEDLLVLWGIHHPNDAAEQTRLYQNPTTYISVGTSTLNQRLVPKIATRSKVNGQSGRMEFFWTILKPNDAINFESNGNFIAPENAYKIVKKGDSTIMKSELEYGNCNTKCQTPIGAINSSMPFHNIHPLTIGECPKYVKSNRLVLATGLRNSPQREGRRKKRGLFGAIAGFIEGGWQGMVDGWYGYHHSNEQGSGYAADKESTQKAIDGVTNKVNSIIDKMNTQFEAVGREFNNLERRIENLNKKMEDGFLDVWTYNAELLVLMENERTLDFHDSNVKNLYDKVRLQLRDNAKELGNGCFEFYHRCDNECMESVRNGTYDYPQYSEEARLKREEISGVKLESIGTYQILSIYSTVASSLALAIMVAGLSLWMCSNGSLQCRICI

SEQ ID NO: 41 - protein, 570 aa, Artificial Sequence; identical to SEQ ID NO: 34
  Sequence alignment illustrating conserved subsequences characteristic of H5 HA.

SEQ ID NO: 42 - protein, 555 aa, Artificial Sequence
  Sequence alignment illustrating conserved subsequences characteristic of H5 HA.
MEKIVLLLAIVSLVKSDQICIGYHANNSTEQVDTIMEKNVTVTHAQDILEKTHNGKLCDLDGVKPLILRDCSVAGWLLGNPMCDEFINVPEWSYIVEKANPANDLYCYPGNFNDYEELKHLLSRINHFEKIQIIPKSSWSDHEASSGVSSACPYLGKSSFFRNVVWLIKKNSAYPTIKKRSYNNTNQEDLLVLWGIHHPNDAAEQTRLYQNPTTYISVGTSTLNQRLVPKIATRSKVNGQSGRMEFFWTILKPNDAINFESNGNFIAPEYAYKIVKKGDSAIMKSELEYGNCNTKCQTPMGAINSSMPFHNIHPLTIGECPKYVKSNRLVLATGLRNSPQRERRRKKRGLFGAIAGFIEGGWQGMVDGWYGYHHSNEQGSGYAADKESTQKAIDGVTNKVNSIIDKMNTQFEAVGREFNNLERRIENLNKKMEDGFLDVWTYNAELLVLMENERTLDFHDSNVKNLYDKVRLQLRDNAKELGNGCFEFYHKCDNECMESIRNGTYNYPQYSEEARLKREEISGVKLESIGIYQILSIYSTVASSLALAIMMAGLS

SEQ ID NO: 43 - protein, 106 aa, Artificial Sequence
  HA sequence element consensus sequence element
CXPXXXXXXXXXXXXXXXXXXXXXXXXXXXXXXXXXXXXXXXXXXXXXCXXXXXXXXXXXXXXXXXXXXWXXXXXXXXXXXXXXXXXXXXXXXXXXXXXXWXXHHP

SEQ ID NO: 44 - protein, 106 aa, Artificial Sequence
  HA sequence element consensus sequence element
CYPXXXXXXXXXXXXXXXXXXXXXXXXXXXXXXXXXXXXXXXXXXTXXCXXXXXXXXXXXXXXXXXXXXWXXXXXXXXXXXXXXXXXXXXXXXXXXXXXXWXXHHP

SEQ ID NO: 45 - protein, 106 aa, Artificial Sequence; identical to SEQ ID NO: 44
  HA sequence element consensus sequence element

SEQ ID NO: 46 - protein, 10 aa, Artificial Sequence
  HA sequence element consensus sequence element
QLSSISSFEK

SEQ ID NO: 47 - protein, 106 aa, Artificial Sequence
  HA sequence element consensus sequence element
CYPXXXXXXXXXXXXXXXXXXXXXXXXXXXXXXXXXXXXXXXXXXSXXCXXXXXXXXXXXXXXXXXXXXWXXXXXXXXXXXXXXXXXXXXXXXXXXXXXXWXXHHP

SEQ ID NO: 48 - protein, 106 aa, Artificial Sequence
  HA sequence element consensus sequence element
CYPXXXXXXXXXXXXXXXXXXXXXXXXXXXXXXXXXXXXXXXXXXSXXCXXXXXXXXXXXXXXXXXXXXWLXXXXXXXXXXXXXXXXXXXXXXXXXXXXXWXXHHP

SEQ ID NO: 49 - protein, 10 aa, Artificial Sequence
  HA sequence element consensus sequence element
XXASSGTLEF

SEQ ID NO: 50 - protein, 106 aa, Artificial Sequence
  HA sequence element consensus sequence element
CYPXXXXXXXXXXXXXXXXXXXXXXXXXXXXXXXXXXXXXXXXXXSSACXXXXXXXXXXXXXXXXXXXXWXXXXXXXXXXXXXXXXXXXXXXXXXXXXXXWXXHHP

SEQ ID NO: 51 - protein, 106 aa, Artificial Sequence
  HA sequence element consensus sequence element
CYPXXXXXXXXXXXXXXXXXXXXXXXXXXXXXXXXXXXXXXXXXXSSACXXXXXXXXXXXXXXXXXXXXWLIXXXXXXXXXXXXXXXXXXXXXXXXXXXXWXXHHP

SEQ ID NO: 52 - protein, 8 aa, Artificial Sequence
  HA sequence element consensus sequence element
NDAAEXXX

SEQ ID NO: 53 - protein, 16 aa, Artificial Sequence
  HA sequence element consensus sequence element
YEELKHLXSXXNHFEK

SEQ ID NO: 54 - protein, 8 aa, Artificial Sequence
  HA sequence element consensus sequence element
GAIAGFIE

SEQ ID NO: 55 - protein, 23 aa, Artificial Sequence
  HA sequence element consensus sequence element
PXXXXXXXXXXXXXXGAIAGFIE

SEQ ID NO: 56 - protein, 17 aa, Artificial Sequence
  HA sequence element consensus sequence element
PSXQSRXXXGAIAGFIE

SEQ ID NO: 57 - protein, 17 aa, Artificial Sequence
  HA sequence element consensus sequence element
PXKXTRXXXGAIAGFIE

SEQ ID NO: 58 - protein, 21 aa, Artificial Sequence
  HA sequence element consensus sequence element
PQRXXXRXXRXXXGAIAGFIE

(19) United States
(12) Patent Application Publication
(10) Pub. No.: US 2011/0257032 A1
(43) Pub. Date: Oct. 20, 2011

(54) MODULAR GLYCAN ARRAYS

(75) Inventors: Ram Sasisekharan, Lexington, MA (US); Karthik Viswanathan, Waltham, MA (US); Udayanath Aich, Brighton, MA (US); Rahul Raman, Waltham, MA (US); Zachary Shriver, Winchester, MA (US); Ido Bachelet, Brookline, MA (US)

(73) Assignee: MASSACHUSETTS INSTITUTE OF TECHNOLOGY, Cambridge, MA (US)

(21) Appl. No.: 13/087,332

(22) Filed: Apr. 14, 2011

Related U.S. Application Data
(60) Provisional application No. 61/324,904, filed on Apr. 16, 2010.

(51) Int. Cl. C40B 30/04; C40B 40/12

(52) U.S. Cl. 506/9; 506/19

(57) ABSTRACT

The present invention provides methods and systems for functionally analyzing glycans and their interaction partners. Among other things, the invention provides modular glycan arrays in which different glycan populations are associated with different discrete solid phase particles. Provided arrays offer many advantages over available systems for assessing glycan binding interactions.

### RELATED APPLICATIONS

The present application claims priority to U.S. Provisional patent application Ser. No. 61/324,904, filed on Apr. 16, 2010, the entire disclosure of which is incorporated herein by reference. In accordance with 37 CFR 1.52(e)(5), a Sequence Listing in the form of a text file (entitled “Sequence Listing.txt,” created on Apr. 13, 2011, and 137 kilobytes) is incorporated herein by reference in its entirety.

### BACKGROUND

Significant effort is dedicated worldwide to the classification of microorganisms, and in particular of viruses. Indeed, fear of the development of pandemic strains, or otherwise noxious organisms, has motivated researchers and governments to invest breathtaking sums of money in the development of systems for classifying and/or detecting microorganisms.

Typically, such systems involve classification of microorganisms into subtypes based on similarities or differences in nucleic acid and/or protein sequences. The present invention encompasses the recognition of certain problems in relying solely on sequence-based classifications to establish microorganism subtypes, and provides novel and surprising solutions. Among other things, the present invention provides modular systems for the rapid characterization and/or detection of microbial species that display relevant glycan binding characteristics.

### SUMMARY

The present invention provides systems for determining functional subtypes of microorganisms, e.g., viruses. Among other things, the invention provides systems for assessing microorganism interactions with glycans. Provided systems can be used to correlate binding characteristics with other attributes of interest. For example, such attributes may include transmissibility of, morbidity caused by, and/or therapeutic responsiveness or resistance of, etc., different defined subtypes. Alternatively or additionally, provided systems may be used to identify, detect, and/or characterize microorganisms having one or more such attributes of interest.

### BRIEF DESCRIPTION OF THE DRAWING

FIG. 1: FIG. 1 is a schematic outline of the glycan microarray technology. As described herein, microarrays are assembled by coating streptavidin-functionalized microparticles with a glycan set selected from a biotinylated glycan library, and probing them using either directly-labeled proteins (e.g., HA, lectins) or virus particles captured with a quantum dot (QD)-anti-HA conjugate reagent. Probed microarrays are analyzed by quantitative flow cytometry.

FIG. 2: FIG. 2A depicts results from exemplary glycan microarrays probed with lectin probes. 3D graphs produced from analysis of LSTa/LSTc microarrays probed with Smabucus nigra lectin (SNA) and Maackia amurensis lectin II (MAL-II), showing selectivity of each lectin to its cognate glycan domain are presented. FIG. 2B depicts quantitative receptor binding analysis of four pandemic influenza strains: SC/18 (H1N1), Ca/04 (H1N1), Wy/03 (H3N2) and Viet/04 (H5N1), demonstrating specificity of H1 and H3 to LSTc (α2-6-linked), and of H5 to LSTa (α2-3-linked).

FIG. 3: FIG. 3 depicts exemplary detection of influenza viruses in biological samples in-vitro and in-vivo. FIG. 3A depicts exemplary determination of QD525-C179 detection threshold. QD525-C179 was used to capture virus particles from allantoic fluid. Particle count was estimated based on a 1.7 mg/mL protein quantity in undiluted sample, and an approximate mass of 500 MDa per particle. At detection threshold (10,000 particles), P value of the signal (LSTc) vs. noise (null particles) ratio was<0.05. B, examination of potential interference of albumin or whole serum on virus detection using QD525-C179, showing good signals in all media types. FIG. 3C depicts an exemplary heat-map summary of viral particle counts detected by QD525-C179 from mice infected with varying starting pfu. Groups A-E, mice groups (A, lowest starting pfu; E, highest starting pfu; 1-4, animal identifiers). Left heat-map was obtained using LSTa microarray, right heat-map using LSTc microarray. FIG. 3D depicts exemplary results of viral particles detected (Y axis) in bronchoalveolar lavage fluids from mice infected with varying infectious titers (X axis).

FIG. 4: FIG. 4 depicts an exemplary gating of singlet particle population in analysis.

FIG. 5: FIG. 5 depicts exemplary representative binding histograms of SNA and MAL-II probing microarrays of 3′SLN-LN and 6′SLN-LN (LN - lactosamine), demonstrating both specificity and dose-response behavior.

FIG. 6: FIG. 6 depicts an exemplary automated conversion of signal intensities to probe molecule number. Fluorescence surface density calibration was performed using MESF FITC reference kits acquiring at least 3 independent times per each MESF level at various photomultiplier voltages (0.3 V increments). Data was collected and integrated into Excel sheets so that data collected at the same PMT voltage would be automatically converted to # probe molecules by the appropriate conversion formula.

FIG. 7: FIG. 7 depicts an exemplary MALDI-MS spectra of LC-linked biotin labeled LSTc (Neu5Acα2-6Galβ1-4GlcNAcβ1-3Galβ1-4Glc-Ez link-LC-Biotin) and LSTa (Neu5Acα2-3Galβ1-4GlcNAcβ1-3Galβ1-4Glc-Ezlink-LC-Biotin).

FIG. 8: Framework for understanding glycan receptor specificity. α2-3- and/or α2-6-linked glycans can adopt different topologies. According to the present invention, the ability of an HA polypeptide to bind to certain of these topologies confers upon it the ability to mediate infection of different hosts, for example, humans. As illustrated in Panel A of this figure, the present invention defines two particularly relevant topologies, a “cone” topology and an “umbrella” topology. The cone topology can be adopted by α2-3- and/or α2-6-linked glycans, and is typical of short oligosaccharides or branched oligosaccharides attached to a core (although this topology can be adopted by certain long oligosaccharides). The umbrella topology can only be adopted by α2-6-linked glycans (presumably due to the increased conformational plurality afforded by the extra C5-C6 bond that is present in the α2-6 linkage), and is predominantly adopted by long oligosaccharides or branched glycans with long oligosaccharide branches, particularly containing the motif Neu5Acα2-6Galβ1-3/4GlcNAc—. As described herein, ability of HA polypeptides to bind the umbrella glycan topology, confers binding to human receptors and/or ability to mediate infection of humans. Panel B of this Figure specifically shows the topology of α2-3 and α2-6 as governed by the glycosidic torsion angles of the trisaccharide motifs—Neu5Acα2-3Galβ1-3/4GlcNAc and Neu5Acα2-6Galβ1-4GlcNAc respectively. A parameter (θ)—angle between C2 atom of Neu5Ac and Cl atoms of the subsequent Gal and GlcNAc sugars in these trisaccharide motifs was defined to characterize the topology. Superimposition of the θ contour and the conformational maps of the α2-3 and α2-6 motifs shows that α2-3 motifs adopt 100% cone-like topology and α2-6 motifs sampled both cone-like and umbrella-like topologies (Panel C). In the cone-like topology sampled by α2-3 and α2-6, GlcNAc and subsequent sugars are positioned along a region spanning a cone. Interactions of HA with cone-like topology primarily involve contacts of amino acids at the numbered positions (based on H3 HA numbering) with Neu5Ac and Gal sugars. On the other hand, in umbrella-like topology, which is unique to α2-6, \GlcNAc and subsequent sugars bend towards the HA binding site (as observed in HA- α2-6 co-crystal structures). Longer α2-6 oligosaccharides (e.g. at least a tetrasaccharide) would favor this conformation since it is stabilized by intra-sugar van der Waals contact between acetyl groups of GlcNAc and Neu5Ac. HA interactions with umbrella-like topology involve contacts of amino acids at the numbered positions (based on H3 HA numbering) with GlcNAc and subsequent sugars in addition to contacts with Neu5Ac and Gal sugars. Panel C of this Figure depicts conformational sampling of cone- and umbrella-like topology by α2-3 and α2-6. Sections (A)-(D) show the conformational (φ,ψ) maps of Neu5Acα2-3Gal, Neu5Acα2-6Gal, Galβ1-3GlcNAc, and Galβ1-4GlcNAc linkages, respectively. These maps obtained from GlycoMaps DB (http://www.glycosciences.de/modeling/glycomapsdb/) were generated using ab initio MD simulations using MM3 force field. Energy distribution is color coded starting from red (representing highest energy) to green representing lowest energy. Encircled regions 1-5 represent (φ,ψ) values observed for the α2-3 and α2-6 oligosaccharides in the HA-glycan co-crystal structures. The trans conformation (encircled region 1) of Neu5Acα2-3Gal predominates in HA binding pocket with the exception of the co-crystal structure of A/Aichi/2/68 H3N2 HA with α2-3 where this conformation is gauche (encircled region 2). On the other hand, the cis conformation of Neu5Acα2-6Gal (encircled region 3) predominates in HA binding pocket. The cone-like topology is sampled by encircled regions 1 and 2 and the umbrella-like topology is sampled by encircled region 3. Sections (E)-(F) show sampling of cone-like and umbrella-like topologies by α2-3 and α2-6 motifs, respectively. Regions marked in red in the conformational maps were used as the outer boundaries to calculate the θ parameter (angle between C2 atom of Neu5Ac and Cl atoms of subsequent Gal and GlcNAc sugars) for a given set of (φ,ψ) values. Based on the energy cutoff, the value of 0>110° was used to characterize cone-like topology and 0<100° was used to characterize umbrella-like topology. Superimposition of the θ contour with the conformational energy map indicated that α2-3 motif adopts 100% cone-like topology since it was energetically unfavorable to adopt umbrella-like topology. On the other hand, the α2-6 motif sampled both the cone-like and umbrella-like topologies and this sampling was classified based on the ω angle (O-C6-C5-H5) of Neu5Acα2-6Gal linkage.

FIG. 9: Conformational map and solvent accessibility of Neu5Acα2-3Gal and Neu5Acα2-6Gal motifs. Panel A shows the conformational map of Neu5Acα2-3Gal linkage. The encircled region 2 is the trans conformation observed in the APR34_H1_{—}23, ADU63_H3_{—}23 and ADS97_H5_{—}23 co-crystal structures. The encircled region 1 is the conformation observed in the AAI68_H3_{—}23 co-crystal structure. Panel B shows the conformational map of Neu5Acα2-6Gal where the cis-conformation (encircled region 3) is observed in all the HA-α2-6 sialylated glycan co-crystal structures. Panel C shows difference between solvent accessible surface area (SASA) of Neu5Ac α2-3 and α2-6 sialylated oligosaccharides in the respective HA-glycan co-crystal structures. The red and cyan bars respectively indicate that Neu5Ac in α2-6 (positive value) or α2-3 (negative value) sialylated glycans makes more contact with glycan binding site. Panel D shows difference between SASA of NeuAc in α2-3 sialylated glycans bound to swine and human H1 (H1_{α2-3}), avian and human H3 (H3_{α2-3}), and of NeuAc in α2-6 sialylated glycans bound to swine and human H1 (H1_{α2-6}). The negative bar in cyan for H3_{α2-3} indicates lesser contact of the human H3 HA with Neu5Acα2-3Gal compared to that of avian H3. Torsion angles—φ: C2-C1-O-C3 (for Neu5Acα2-3/6 linkage); ψ: C1-O-C3-H3 (for Neu5Acα2-3Gal) or C1-O-C6-C5 (for Neu5Acα2-6Gal); ω: O-C6-C5-H5 (for Neu5Acα2-6Gal) linkages. The φ, ψ maps were obtained from GlycoMaps DB (http://www.glycosciences.de/modeling/glycomapsdb/) which was developed by Dr. Martin Frank and Dr. Claus-Wilhelm von der Lieth (German Cancer Research Institute, Heidelberg, Germany). The coloring scheme from high energy to low energy is from bright red to bright green, respectively.

FIG. 10: Exemplary cone topologies. This Figure illustrates certain exemplary (but not exhaustive) glycan structures that adopt cone topologies.

FIG. 11: Exemplary umbrella topologies. (A) Certain exemplary (but not exhaustive) N- and O-linked glycan structures that can adopt umbrella topologies. (B) Certain exemplary (but not exhaustive) 0-linked glycan structures that can adopt umbrella topologies.

FIG. 12: Alignment of exemplary sequences of wild type HA. Sequences were obtained from the NCBI influenza virus sequence database (http://www.ncbi.nlm.nih.gov/genomes/FLU/FLU.html)

FIG. 13: Sequence alignment of HA glycan binding domain. Gray: conserved amino acids involved in binding to sialic acid. Red: particular amino acids involved in binding to Neu5Acα2-3/6Gal motifs. Yellow: amino acids that influence positioning of Q226 (137, 138) and E190 (186, 228). Green: amino acids involved in binding to other monosaccharides (or modifications) attached to Neu5Acα2-3/6Gal motif. The sequence for ASI30, APR34, ADU63, ADS97 and Viet04 were obtained from their respective crystal structures. The other sequences were obtained from SwissProt (http://us.expasy.org). Abbreviations: ADA76, A/duck/Alberta/35/76 (H1N1); ASI30, A/Swine/Iowa/30 (H1N1); APR34, A/Puerto Rico/8/34 (H1N1); ASC18, A/South Carolina/1/18 (H1N1), AT91, A/Texas/36/91 (H1N1); ANY18, A/New York/1/18 (H1N1); ADU63, A/Duck/Ukraine/1/63 (H3N8); AAI68, A/Aichi/2/68 (H3N2); AM99, A/Moscow/10/99 (H3N2); ADS97, A/Duck/Singapore/3/97 (H5N3); Viet04, A/Vietnam/1203/2004 (H5N1).

FIG. 14: Sequence alignment illustrating conserved subsequences characteristic of H1 HA.

FIG. 15: Sequence alignment illustrating conserved subsequences characteristic of H3 HA.

FIG. 16: Sequence alignment illustrating conserved subsequences characteristic of H5 HA.

### DESCRIPTION OF HA SEQUENCE ELEMENTS

### HA Sequence Element 1

HA Sequence Element 1 is a sequence element corresponding approximately to residues 97-185 (where residue positions are assigned using H3 HA as reference) of many HA proteins found in natural influenza isolates. This sequence element has the basic structure:

| | |
|---|---|
| C (Y/F) P X₁ C X₂ W X₃ W X₄ H H P, | (SEQ ID NO: 43) |

wherein:
X₁ is approximately 30-45 amino acids long;
X₂ is approximately 5-20 amino acids long;
X₃ is approximately 25-30 amino acids long; and
X₄ is approximately 2 amino acids long.

In some embodiments, X₁ is about 35-45, or about 35-43, or about 35, 36, 37, 38, 38, 40, 41, 42, or 43 amino acids long. In some embodiments, X₂ is about 9-15, or about 9-14, or about 9, 10, 11, 12, 13, or 14 amino acids long. In some embodiments, X₃ is about 26-28, or about 26, 27, or 28 amino acids long. In some embodiments, X₄ has the sequence (G/A) (I/V). In some embodiments, X₄ has the sequence GI; in some embodiments, X₄ has the sequence GV; in some embodiments, X₄ has the sequence AI; in some embodiments, X₄ has the sequence AV. In some embodiments, HA Sequence Element 1 comprises a disulfide bond. In some embodiments, this disulfide bond bridges residues corresponding to positions 97 and 139 (based on the canonical H3 numbering system utilized herein).

In some embodiments, and particularly in H1 polypeptides, X₁ is about 43 amino acids long, and/or X₂ is about 13 amino acids long, and/or X₃ is about 26 amino acids long. In some embodiments, and particularly in H1 polypeptides, HA Sequence Element 1 has the structure:

(SEQ ID NO: 44)
C Y P X_{1A} T (A/T)(A/S) C X₂ W X₃ W X₄ H H P,

wherein:
X_{1A} is approximately 27-42, or approximately 32-42, or approximately 32-40, or approximately 26-41, or approximately 31-41, or approximately 31-39, or approximately 31, 32, 33, 34, 35, 36, 37, 38, 39, or 40 amino acids long, and X₂-X₄ are as above.

In some embodiments, and particularly in H1 polypeptides, HA Sequence Element 1 has the structure:

(SEQ ID NO: 45)
C Y P X_{1A} T (A/T)(A/S) C X₂ W (I/L)(T/V) X_{3A} W X₄
H H P,

wherein:
X_{1A} is approximately 27-42, or approximately 32-42, or approximately 32-40, or approximately 32, 33, 34, 35, 36, 37, 38, 39, or 40 amino acids long,
X_{3A} is approximately 23-28, or approximately 24-26, or approximately 24, 25, or 26 amino acids long, and X₂ and X₄ are as above.

In some embodiments, and particularly in H1 polypeptides, HA Sequence Element 1 includes the sequence:

| | |
|---|---|
| Q L S S I S S F E K, | (SEQ ID NO: 46) |

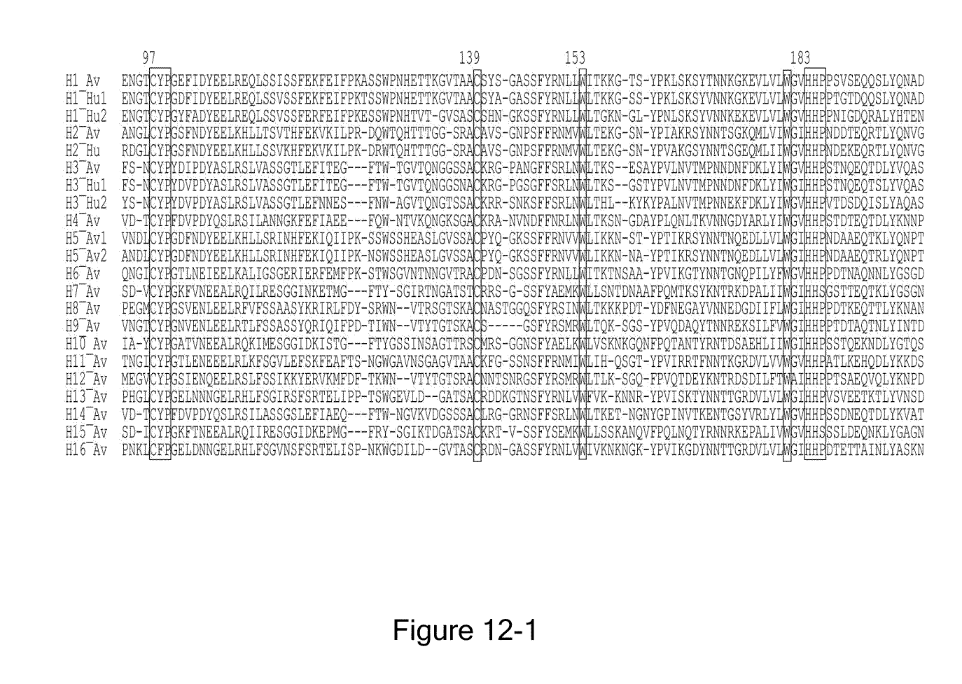

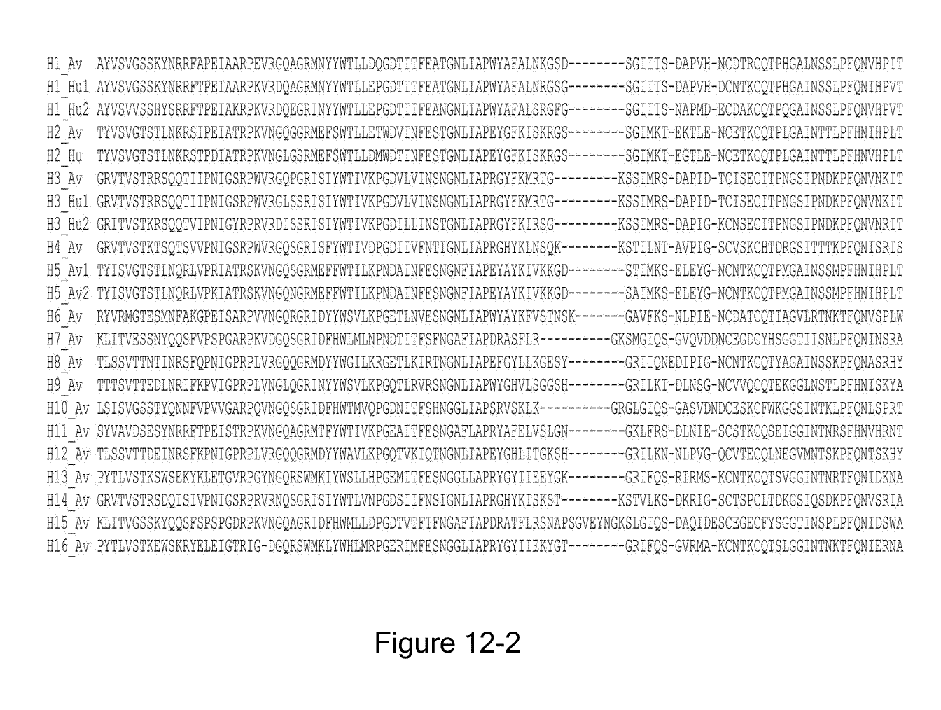

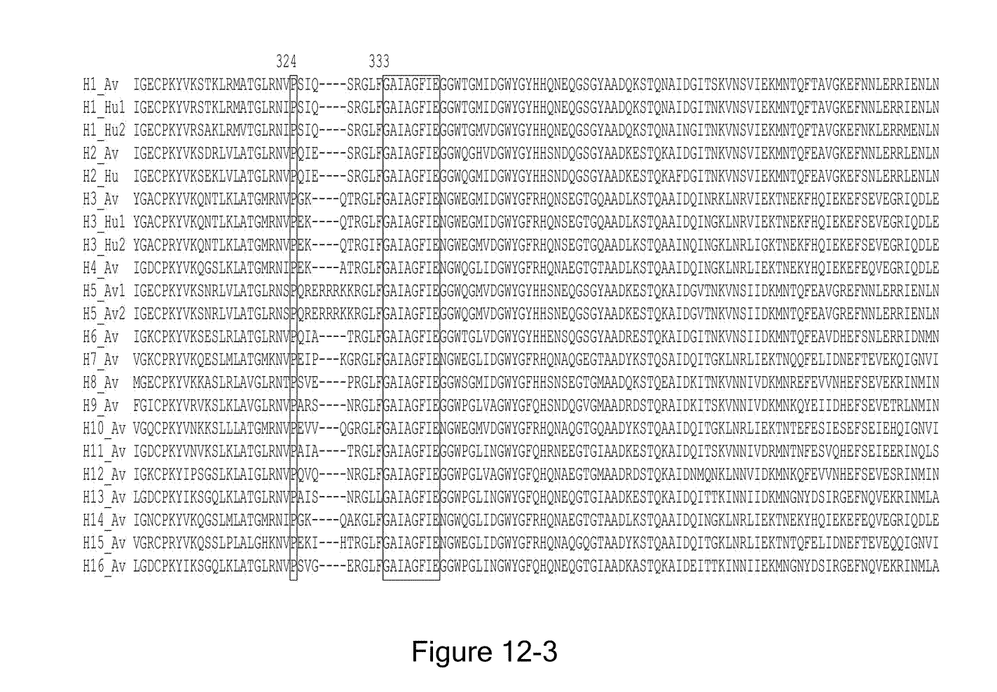

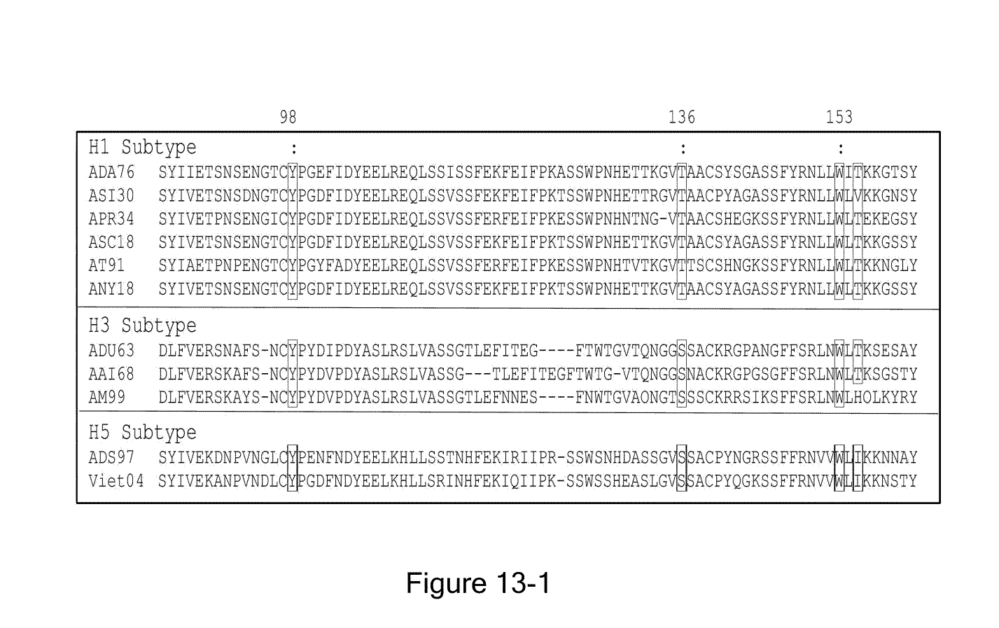

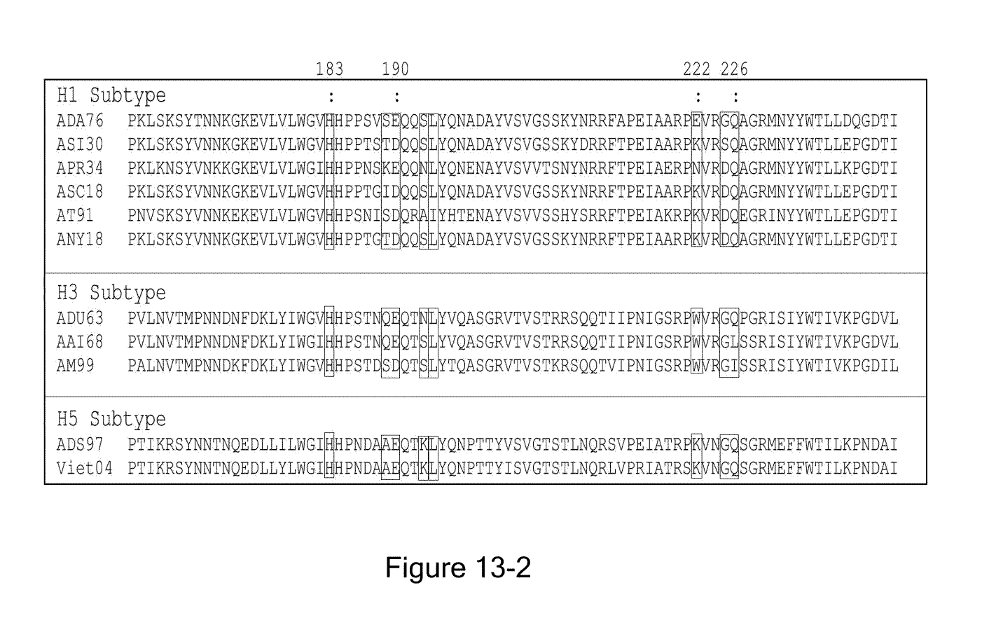

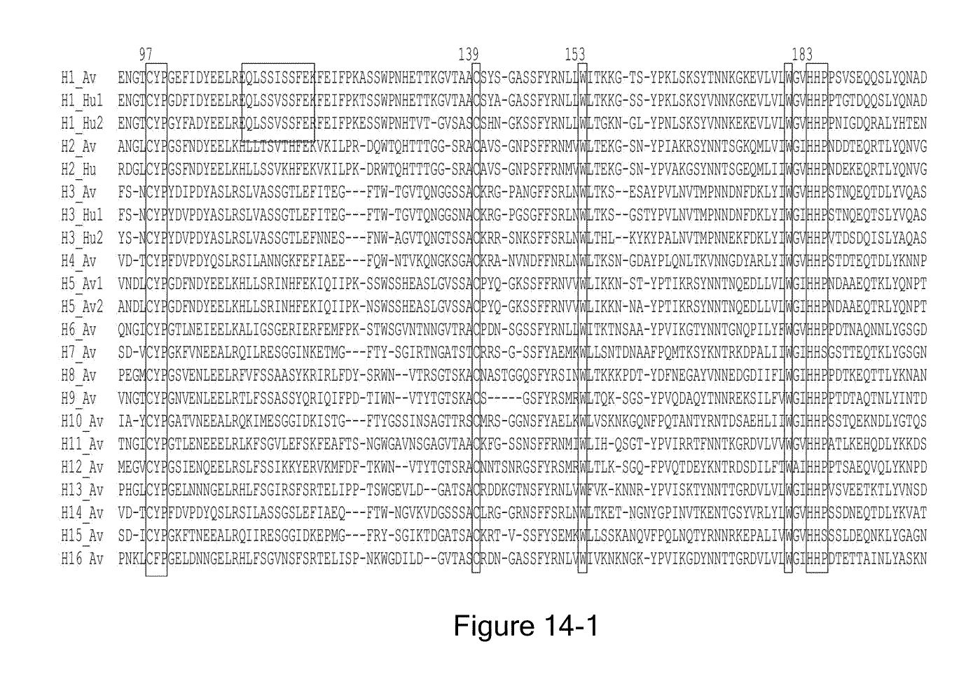

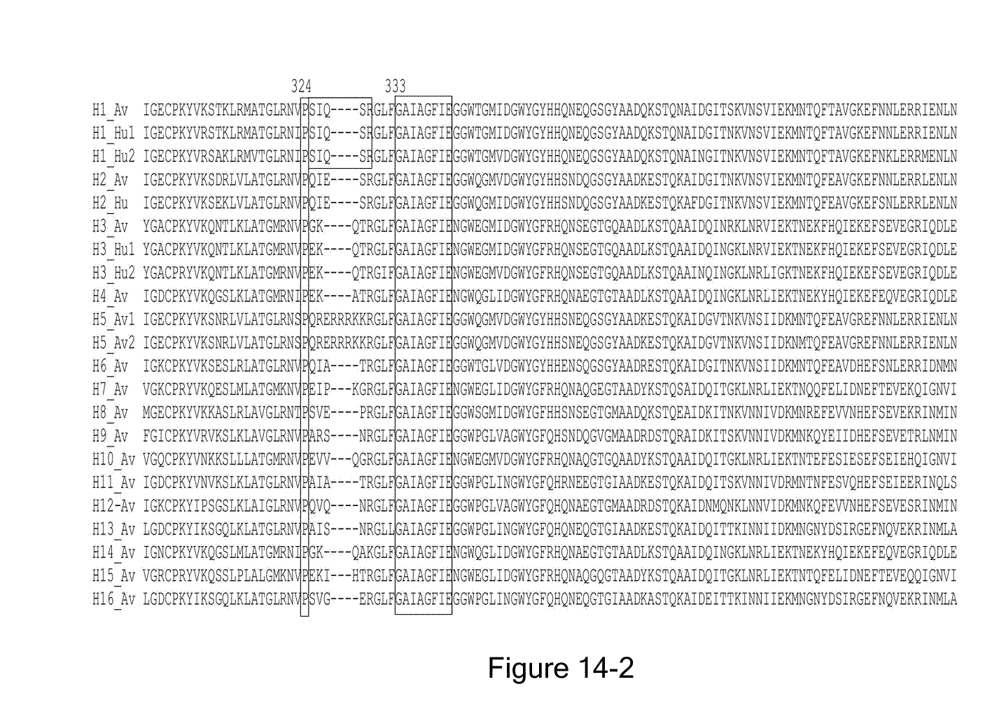

typically within X₁, (including within X_{1A}) and especially beginning about residue 12 of X₁ (as illustrated, for example, in FIGS. 12-14).

In some embodiments, and particularly in H3 polypeptides, X₁ is about 39 amino acids long, and/or X₂ is about 13 amino acids long, and/or X₃ is about 26 amino acids long.

In some embodiments, and particularly in H3 polypeptides, HA Sequence Element 1 has the structure:

(SEQ ID NO: 47)
C Y P X_{1A} S (S/N)(A/S) C X₂ W X₃ W X₄ H H P,

wherein:
X_{1A} is approximately 27-42, or approximately 32-42, or approximately 32-40, or approximately 23-38, or approximately 28-38, or approximately 28-36, or approximately 28, 29, 30, 31, 32, 33, 34, 35, 36, 37, 38, 39, or 40 amino acids long, and X₂-X₄ are as above.

In some embodiments, and particularly in H3 polypeptides, HA Sequence Element 1 has the structure:

(SEQ ID NO: 48)
C Y P X_{1A} S (S/N)(A/S) C X₂ W L (T/H) X_{3A} W X₄ H H
P,

wherein:
X_{1A} is approximately 27-42, or approximately 32-42, or approximately 32-40, or approximately 32, 33, 34, 35, 36, 37, 38, 39, or 40 amino acids long,
X_{3A} is approximately 23-28, or approximately 24-26, or approximately 24, 25, or 26 amino acids long, and X₂ and X₄ are as above.

In some embodiments, and particularly in H3 polypeptides, HA Sequence Element 1 includes the sequence:

| | |
|---|---|
| (L/I)(V/I) A S S G T L E F, | (SEQ ID NO: 49) |

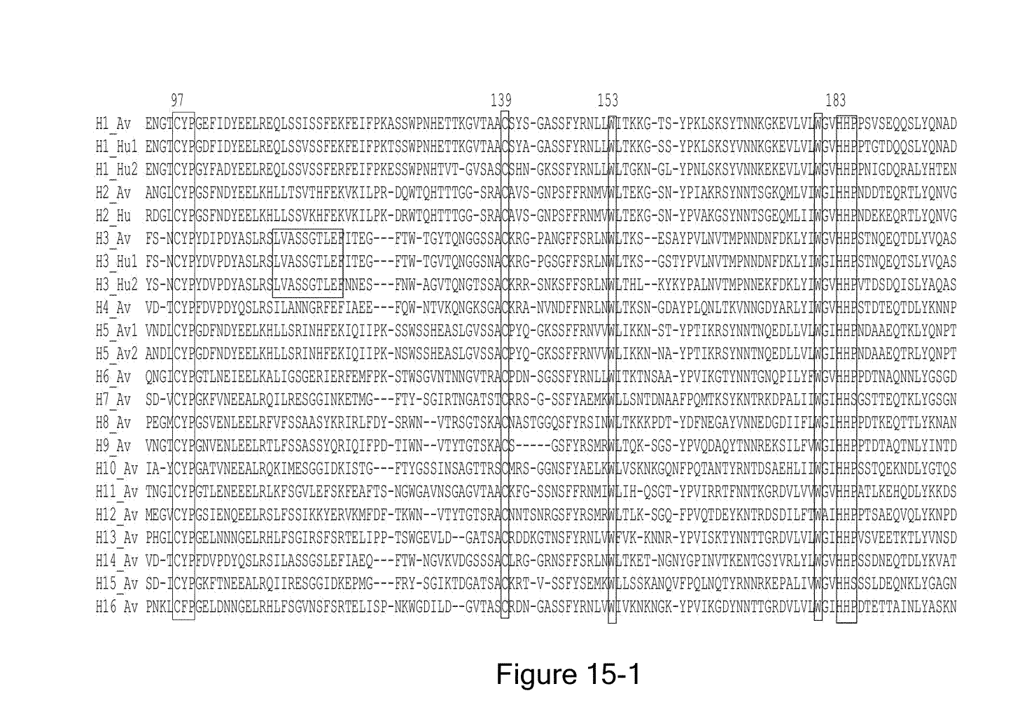

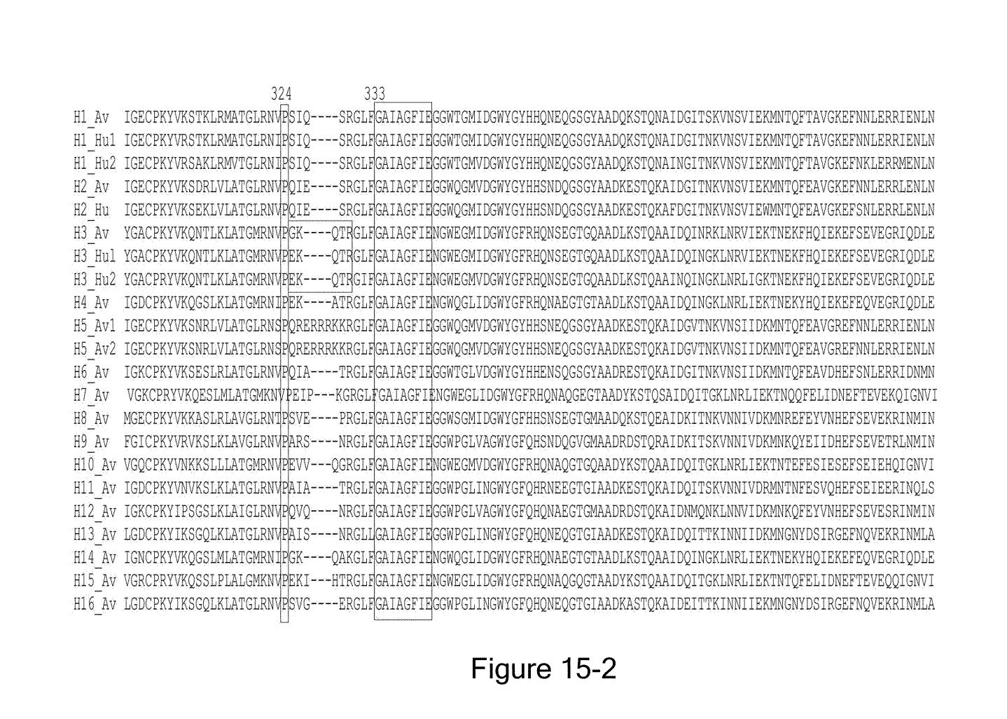

typically within X₁ (including within X_{1A}), and especially beginning about residue 12 of X₁ (as illustrated, for example, in FIGS. 12, 13, and 15).

In some embodiments, and particularly in H5 polypeptides, X₁ is about 42 amino acids long, and/or X₂ is about 13 amino acids long, and/or X₃ is about 26 amino acids long.

In some embodiments, and particularly in H5 polypeptides, HA Sequence Element 1 has the structure:

(SEQ ID NO: 50)
C Y P X_{1A} S S A C X₂ W X₃ W X₄ H H P,

wherein:
X_{1A} is approximately 27-42, or approximately 32-42, or approximately 32-40, or approximately 23-38, or approximately 28-38, or approximately 28-36, or approximately 28, 29, 30, 31, 32, 33, 34, 35, 36, 37, 38, 39, or 40 amino acids long, and X₂-X₄ are as.

In some embodiments, and particularly in H5 polypeptides, HA Sequence Element 1 has the structure:

(SEQ ID NO: 51)
C Y P X_{1A} S S A C X₂ W L I X_{3A} W X₄ H H P,

wherein:
X_{1A} is approximately 27-42, or approximately 32-42, or approximately 32-40, or approximately 32, 33, 34, 35, 36, 37, 38, 39, or 40 amino acids long, and
X_{3A} is approximately 23-28, or approximately 24-26, or approximately 24, 25, or 26 amino acids long, and X₂ and X₄ are as above.

In some embodiments, and particularly in H5 polypeptides, HA Sequence Element 1 is extended (i.e., at a position corresponding to residues 186-193) by the sequence:

| | |
|---|---|
| N D A A E X X (K/R) | (SEQ ID NO: 52) |

In some embodiments, and particularly in H5 polypeptides, HA Sequence Element 1 includes the sequence:

| | |
|---|---|
| Y E E L K H L X S X X N H F E K, | (SEQ ID NO: 53) |

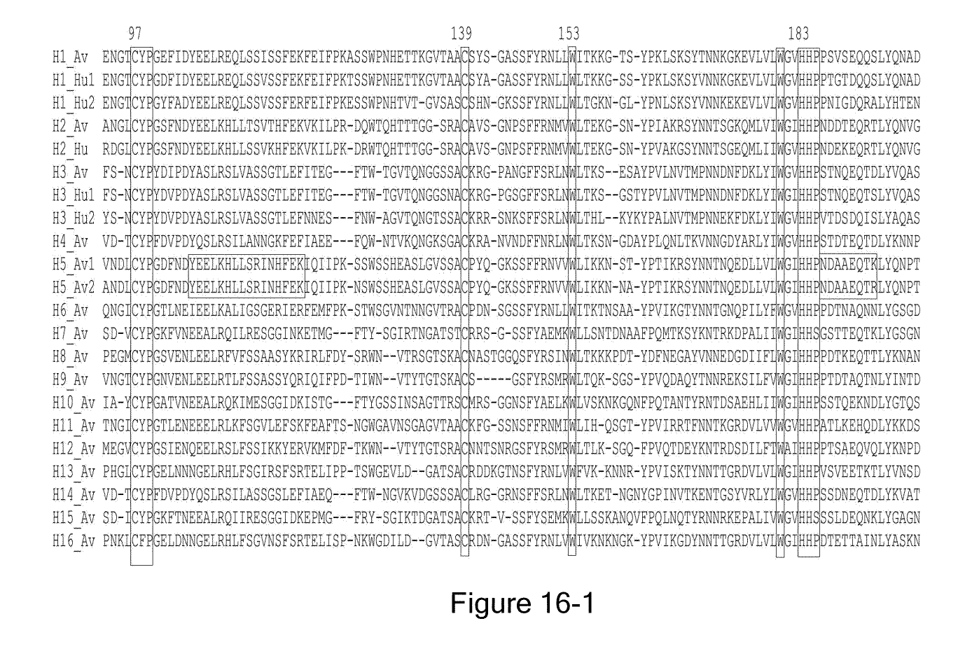

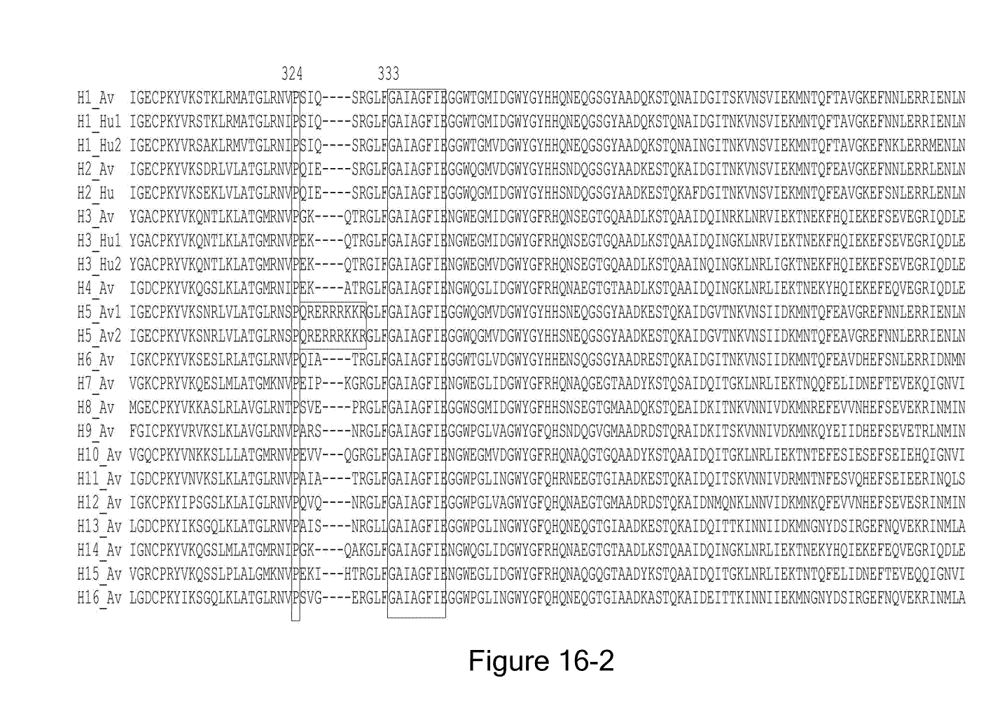

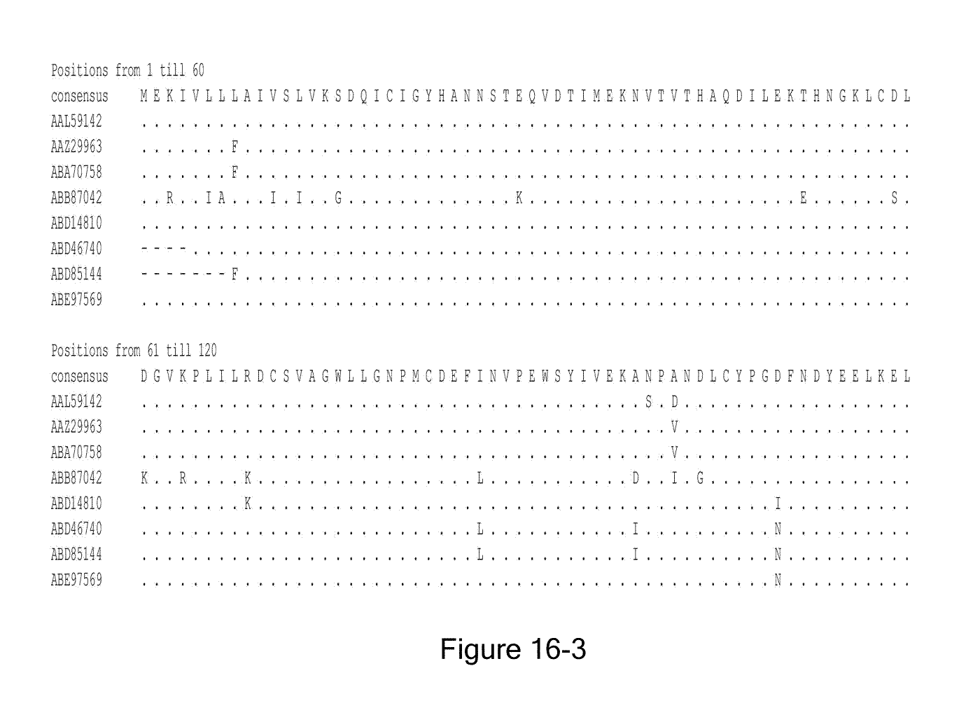

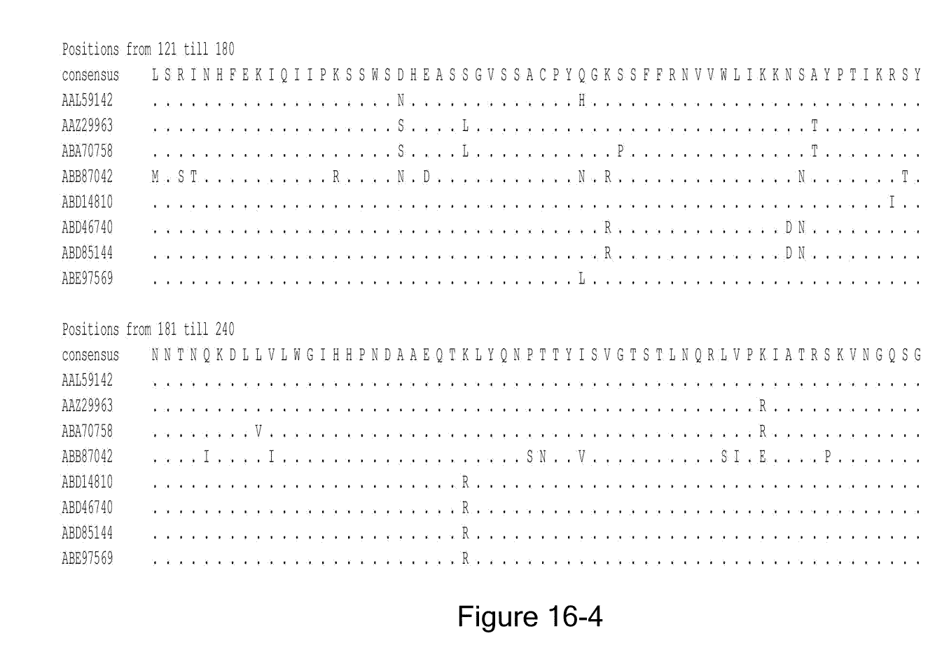

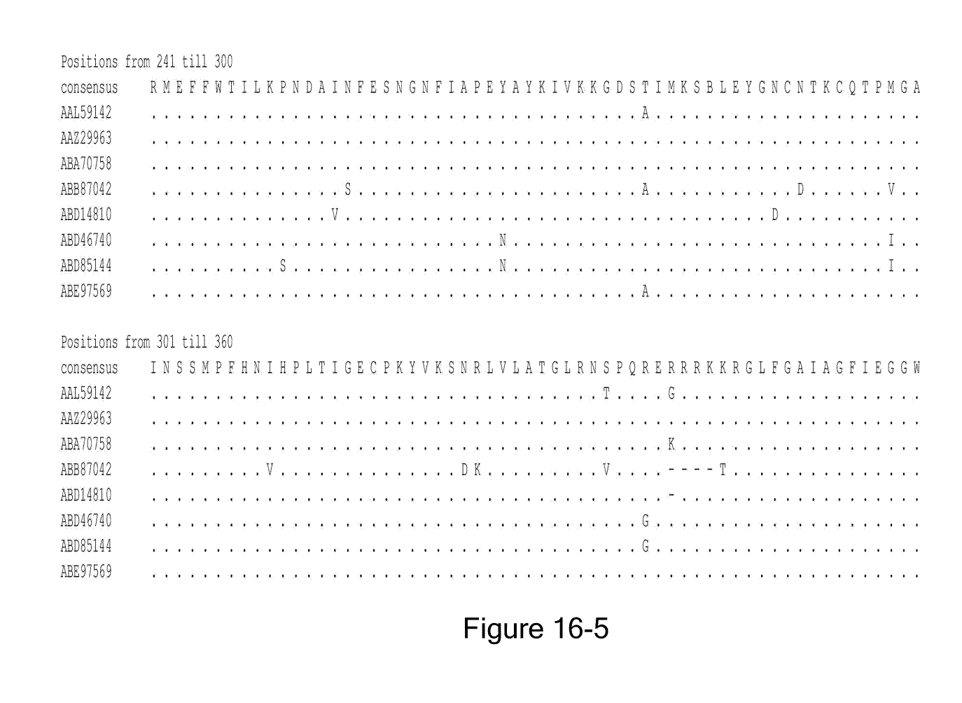

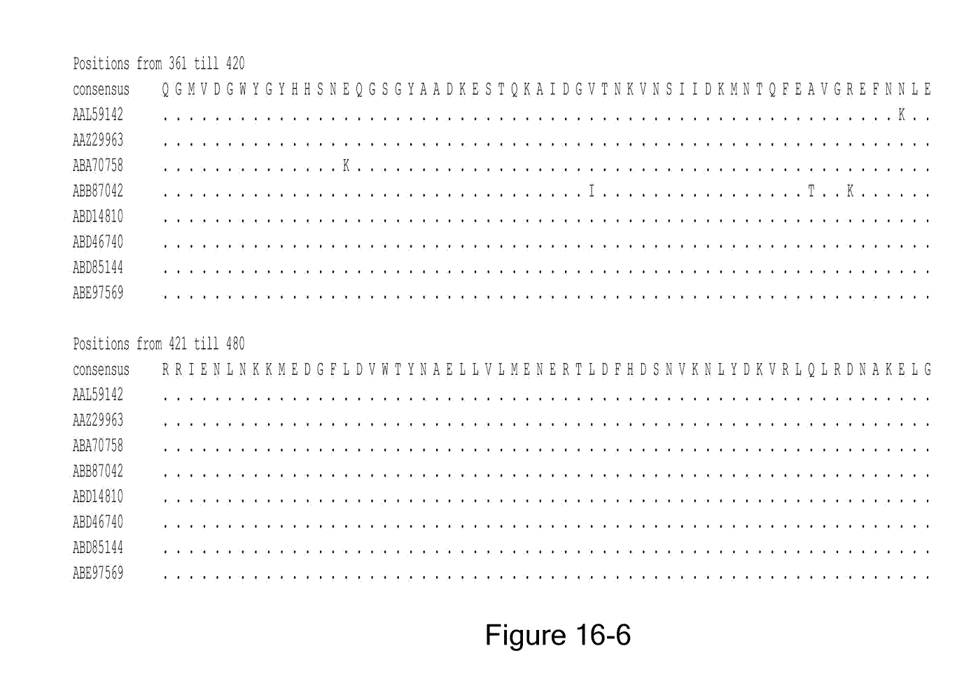

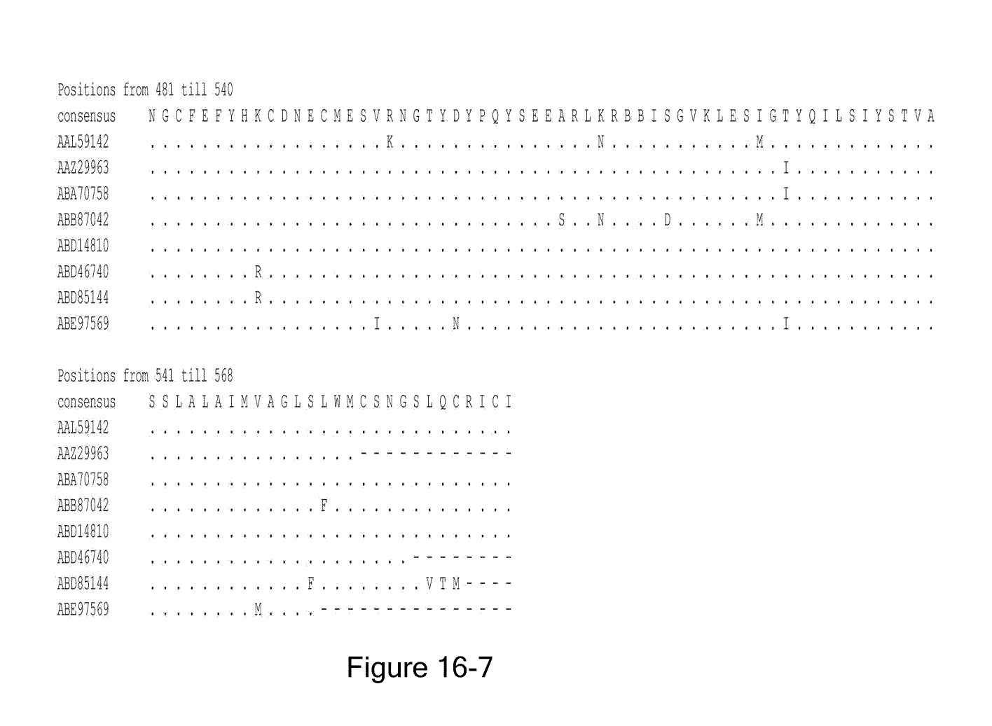

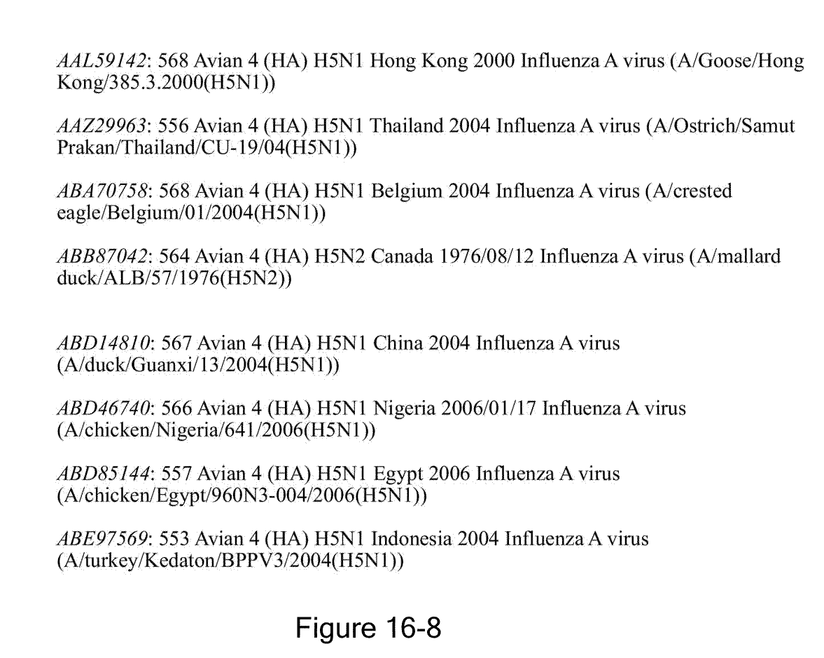

typically within X₁, and especially beginning about residue 6 of X₁ (as illustrated, for example, in FIGS. 12, 13, and 16).

### HA Sequence Element 2

HA Sequence Element 2 is a sequence element corresponding approximately to residues 324-340 (again using a numbering system based on H3 HA) of many HA proteins found in natural influenza isolates. This sequence element has the basic structure:

| | |
|---|---|
| G A I A G F I E | (SEQ ID NO: 54) |

In some embodiments, HA Sequence Element 2 has the sequence:

| | |
|---|---|
| P X₁G A I A G F I E, | (SEQ ID NO: 55) |

wherein:
X₁ is approximately 4-14 amino acids long, or about 8-12 amino acids long, or about 12, 11, 10, 9 or 8 amino acids long. In some embodiments, this sequence element provides the HAO cleavage site, allowing production of HAl and HA2.

In some embodiments, and particularly in H1 polypeptides, HA Sequence Element 2 has the structure:

(SEQ ID NO: 56)
P S (I/V) Q S R X_{1A} G A I A G F I E,

wherein:
X_{1A} is approximately 3 amino acids long; in some embodiments, X_{1A} is G (L/I) F.

In some embodiments, and particularly in H3 polypeptides, HA Sequence Element 2 has the structure:

| | |
|---|---|
| P X K X T R X_{1A} G A I A G F I E, | (SEQ ID NO: 57) |

wherein:
X_{1A} is approximately 3 amino acids long; in some embodiments, X_{1A} is G (L/I) F.

In some embodiments, and particularly in H5 polypeptides, HA Sequence Element 2 has the structure:

(SEQ ID NO: 58)
P Q R X X X R X X R X_{1A} G A I A G F I E,

wherein:
X_{1A} is approximately 3 amino acids long; in some embodiments, X_{1A} is G (L/I) F.

### DEFINITIONS

Affinity: As is known in the art, “affinity” is a measure of the tightness with which a particular ligand (e.g., an HA polypeptide) binds to its partner (e.g., and HA receptor). Affinities can be measured in different ways. For example,

Array: The term “array”, as used herein, refers to a collection of individual supports, each of which has attached thereto a different glycan or set of glycans.

Associated with: The term “associated with”, in its most general sense, refers to any direct or indirect attachment between two (or more) entities. In some embodiments, the entities are directly associated with one another in that there is no intervening entity (i.e., linker). In some embodiments, entities are considered to be directly associated with one another if they are covalently bound to one another. In some embodiments, an association is a covalent association. In some embodiments, an association is a non-covalent association (e.g., involving one or more of hydrophobic forces, van der Waals forces, hydrogen bonds, magnetic interactions, etc). In some embodiments, entities are reversibly associated with one another in that the association can be disrupted under certain (typically predetermined) conditions. In some embodiments, entities are irreversibly associated with one another. In some embodiments, an association involves specific binding.

Biologically active: As used herein, the phrase “biologically active” refers to a characteristic of an agent that has activity in a biological system. In some embodiments, a biologically active agent shows biological activity in the context of an organism. For instance, an agent that, when administered to an organism, has a biological effect on that organism, is considered to be biologically active. In particular embodiments, where a protein or polypeptide is biologically active, a portion of that protein or polypeptide that shares at least one biological activity of the protein or polypeptide is typically referred to as a “biologically active” portion.

Characteristic portion: As used herein, the phrase a “characteristic portion” of a polypeptide is a fragment of that polypeptide that contains at least one characteristic sequence of the polypeptide. In some embodiments, a characteristic portion also shows at least one activity of the relevant complete polypeptide.

Characteristic sequence: A “characteristic sequence” is a sequence that can be used to classify a polypeptide. For example, a characteristic sequence element may be one that is unique to the polypeptide in that it is not found in other known polypeptides (e.g., whose sequences are included in established databases such as GenBank, etc). In some embodiment, a characteristic sequence element is one that is found in all members of a family of polypeptides (or nucleic acids), but not in polypeptides (or nucleic acids) that are not members of the family, and therefore can be used by those of ordinary skill in the art to define members of the family. In some embodiments, a characteristic sequence spans at least 5, 6, 7, 8, 9, 10, 11, 12, 13, 14, 15, 16, 17, 18, 19, 20 or more amino acids (nucleic acids). In some embodiments, a characteristic sequence element spans at least 20, 25, 30, 25, 40, 45, 50, 55, 60, 65, 70, 75, 80, 85, 90, 95, 100, 110, 120, 130, 140, 150, 160, 170, 180, 190, 200, 21, 220, 230, 240, 250, 260 270, 280, 290, 300 or more amino acids (nucleic acids).

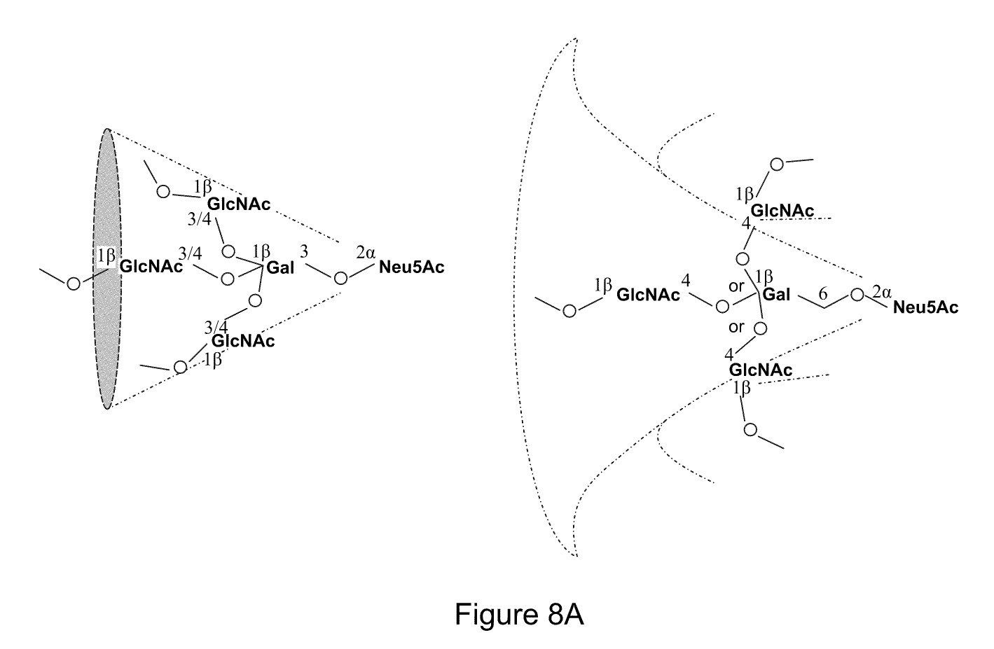

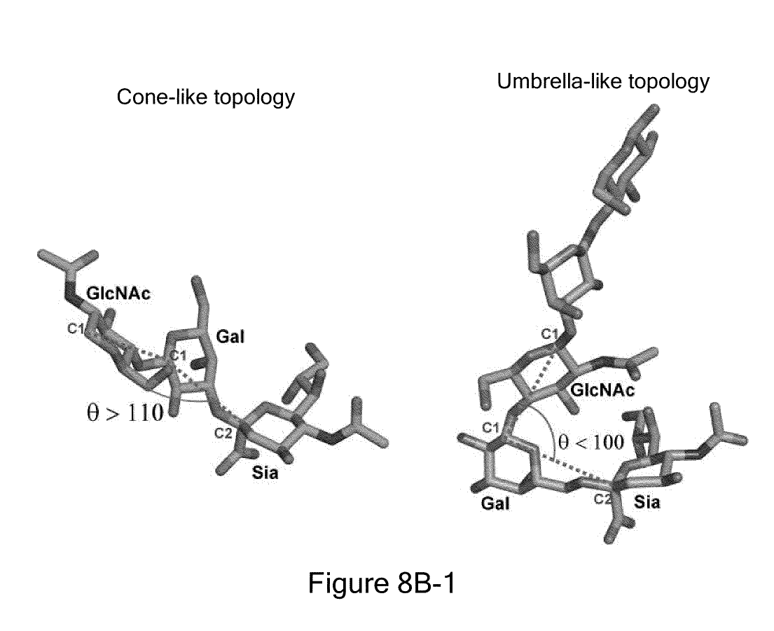

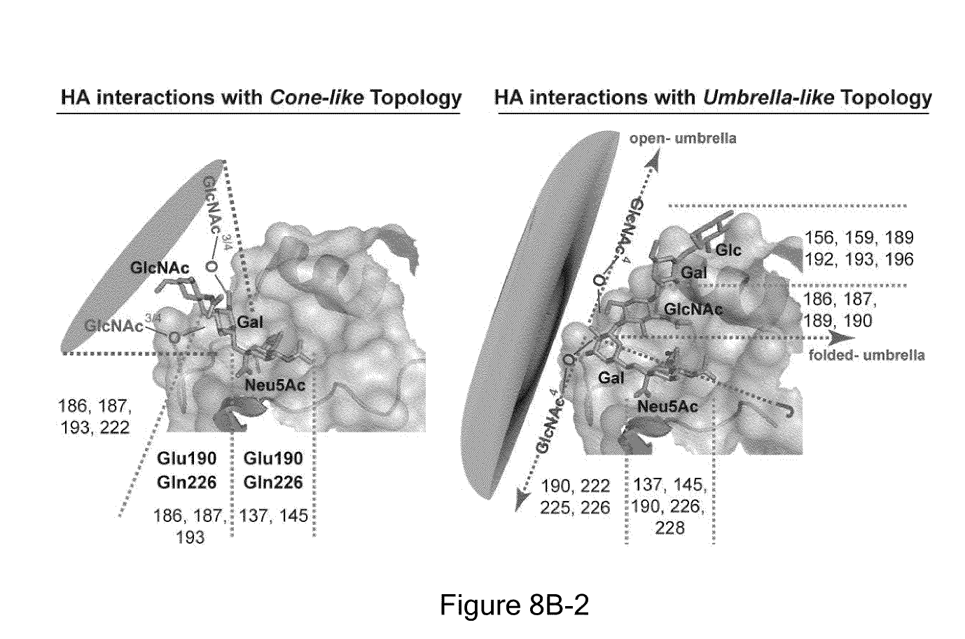

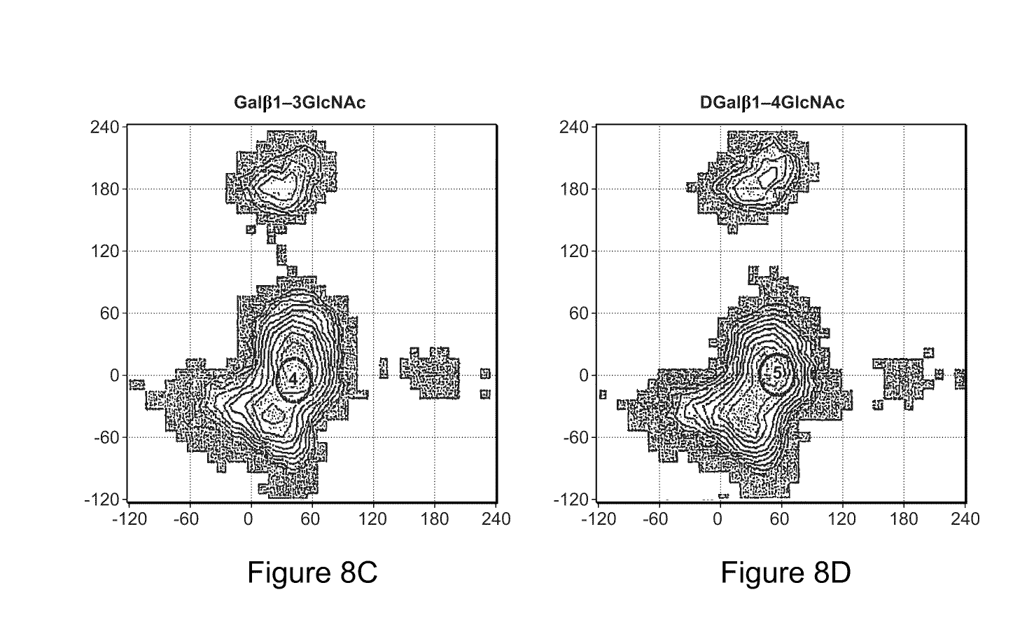

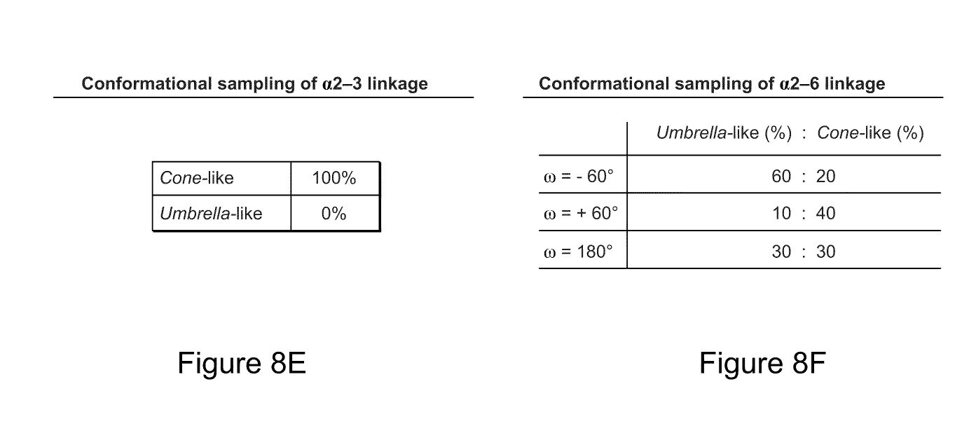

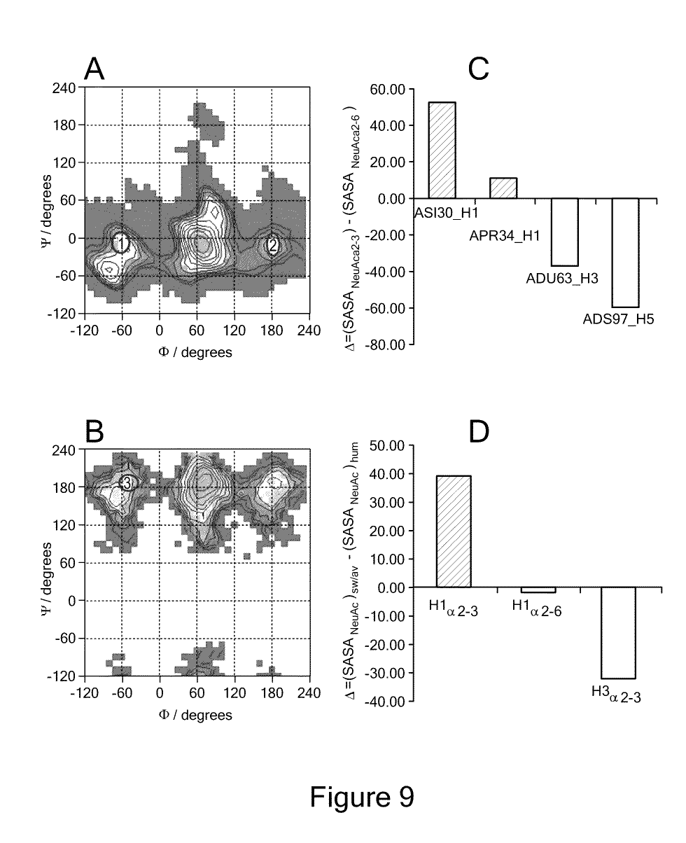

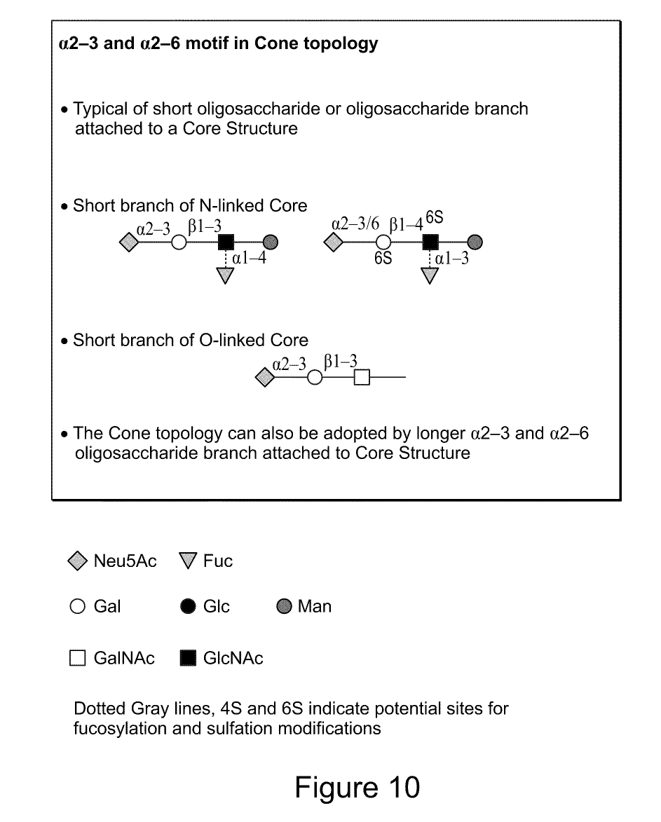

Cone topology: The phrase “cone topology” is used herein to refer to a 3-dimensional arrangement adopted by certain glycans and in particular by glycans on HA receptors. As illustrated in FIG. 8, cone topology can be adopted by α2-3 sialylated glycans or by α2-6 sialylated glycans, and is typical of short oligonucleotide chains, though some long oligonucleotides can also adopt this conformation. Cone topology is characterized by the glycosidic torsion angles of Neu5Acα2-3Gal linkage which samples three regions of minimum energy conformations given by φ(C1-C2-O-C3/C6) value of around −60, 60 or 180 and ψ (C2-O-C3/C6-H3/C5) samples −60 to 60 (see FIG. 9). FIG. 10 presents certain representative (though not exhaustive) examples of glycans that adopt a cone topology.

Corresponding to: As used herein, the term “corresponding to” is often used to designate the position/identity of an amino acid residue in a polypeptide. Those of ordinary skill will appreciate that, for purposes of simplicity, a canonical numbering system is typically used to designate positions in a polypeptide with reference to a particular established reference polypeptide, so that an amino acid “corresponding to” a residue at position 190, for example, need not actually be the 190^{th} amino acid in a particular amino acid chain but rather corresponds to the residue found at 190 in the reference polypeptide; those of ordinary skill in the art readily appreciate how to identify corresponding amino acids.

Engineered: The term “engineered”, as used herein, describes a polypeptide that (1) has been produced through the hand of man; and/or (2) whose amino acid sequence has been selected by man.

Glycan: As is known in the art and used herein “glycans” are sugars. Glycans can be monomers or polymers of sugar residues, but typically contain at least three sugars, and can be linear or branched. A glycan may include natural sugar residues (e.g., glucose, N-acetylglucosamine, N-acetyl neuraminic acid, galactose, mannose, fucose, hexose, arabinose, ribose, xylose, etc.) and/or modified sugars (e.g., 2′-fluororibose, 2′-deoxyribose, phosphomannose, 6′sulfo N-acetylglucosamine, etc). The term “glycan” includes homo and heteropolymers of sugar residues. The term “glycan” can refer to a glycan component of a glycoconjugate (e.g., of a glycoprotein, glycolipid, proteoglycan, etc.). The term also encompasses free glycans, including glycans that have been cleaved or otherwise released from a glycoconjugate.

Glycan binding agents: The term “glycan binding agents”, as used herein, refers to agents of any chemical class that interact specifically with glycans. In many embodiments, glycan binding agents comprise polypeptides. For example, a wide variety of polypeptides have glycan binding activities in nature. An important family of proteins, often referred to as glycan binding proteins (GBPs), bind to N-linked and O-linked glycans on various glycoproteins and mediate cell-cell adhesion, signaling and trafficking events in immune responses. The main classes of GBPs include C-type lectins, galectins and siglecs. GBPs are typically either expressed as soluble or membrane bound proteins in the monomeric or multimeric forms with multiple glycan binding sites. Also, GBPs can be dispersed on the cell surface or localized in a microenvironment. The glycan binding site in a GBP is also known as a carbohydrate recognition domain (CRD). CRDs on GBPs typically accommodate mono—tetrasaccharide glycan ligand motifs. The interaction between a single CRD and a glycan motif is typically low affinity with values in μM range. However, most of the physiological glycan-GBP interactions are multivalent involving binding of an ensemble of glycan motifs to multimeric CRDs formed by association of GBPs. Thus, unlike protein-protein interactions which either activate or inhibit protein function (digital regulation), glycan-GBP interactions fine tune (analog modulation) protein function through avidity, graded affinity and multivalency.

HI polypeptide: An “Hl polypeptide”, as that term is used herein, is an HA polypeptide whose amino acid sequence includes at least one sequence element that is characteristic of H1 and distinguishes H1 from other HA subtypes. Representative such sequence elements can be determined by alignments as will be understood by those of ordinary skill in the art and include, for example, those described herein with regard to H1-specific embodiments of HA Sequence Elements.

H3 polypeptide: An “H3 polypeptide”, as that term is used herein, is an HA polypeptide whose amino acid sequence includes at least one sequence element that is characteristic of H3 and distinguishes H3 from other HA subtypes. Representative such sequence elements can be determined by alignments as will be understood by those of ordinary skill in the art and include, for example, those described herein with regard to H3-specific embodiments of HA Sequence Elements.

H5 polypeptide: An “H5 polypeptide”, as that term is used herein, is an HA polypeptide whose amino acid sequence includes at least one sequence element that is characteristic of H5 and distinguishes H5 from other HA subtypes. Representative such sequence elements can be determined by alignments as will be understood by those of ordinary skill in the art and include, for example, those described herein with regard to H5-specific embodiments of HA Sequence Elements.

Hemagglutinin (HA) polypeptide: As used herein, the term “hemagglutinin polypeptide” (or “HA polypeptide’) refers to a polypeptide whose amino acid sequence includes at least one characteristic sequence of HA. A wide variety of HA sequences from influenza isolates are known in the art; indeed, the National Center for Biotechnology Information (NCBI) maintains a database (www.ncbi.nlm.nih.gov/genomes/FLU/flu.html) that, as of the filing of the present application included 9796 HA sequences. Those of ordinary skill in the art, referring to this database, can readily identify sequences that are characteristic of HA polypeptides generally, and/or of particular HA polypeptides (e.g., H1, H2, H3, H4, H5, H6, H7, H8, H9, H10, H11, H12, H13, H14, H15, or H16 polypeptides; or of HAs that mediate infection of particular hosts, e.g., avian, camel, canine, cat, civet, environment, equine, human, leopard, mink, mouse, seal, stone martin, swine, tiger, whale, etc. For example, in some embodiments, an HA polypeptide includes one or more characteristic sequence elements found between about residues 97 and 185, 324 and 340, 96 and 100, and/or 130-230 of an HA protein found in a natural isolate of an influenza virus. In some embodiments, an HA polypeptide has an amino acid sequence comprising at least one of HA Sequence Elements 1 and 2, as defined herein. In some embodiments, an HA polypeptide has an amino acid sequence comprising HA Sequence Elements 1 and 2, in some embodiments separated from one another by about 100-200, or by about 125-175, or about 125-160, or about 125-150, or about 129-139, or about 129, 130, 131, 132, 133, 134, 135, 136, 137, 138, or 139 amino acids. In some embodiments, an HA polypeptide has an amino acid sequence that includes residues at positions within the regions 96-100 and/or 130-230 that participate in glycan binding. For example, many HA polypeptides include one or more of the following residues: Tyr98, Ser/Thr136, Trp153, His183, and Leu/I1le194. In some embodiments, an HA polypeptide includes at least 2, 3, 4, or all 5 of these residues.

Isolated: The term “isolated”, as used herein, refers to an agent or entity that has (i) been separated from at least some of the components with which it was associated when initially produced (whether in nature or in an experimental setting); and/or (ii) produced by the hand of man. Isolated agents or entities may be separated from at least about 10%, 20%, 30%, 40%, 50%, 60%, 70%, 80%, 90%, or more of the other components with which they were initially associated. In some embodiments, isolated agents are more than 90%, 91%, 92%, 93%, 94%, 95%, 96%, 97%, 98%, 99% pure.

Label: In general, a “label” is any aspect or entity susceptible to being detected. To give but a few examples, a label may be or comprise a color, a tag, a fluorophore, a radioactive moiety, an epitope (e.g., recognized by an antibody), an oligonucleotide or other specific binding partner, a bar code, etc. An entity is considered to be “labeled” if it is associated with a label or with an agent that itself, or together with other agents, generates a label. In some embodiments, a label may be or comprise a dyes, or mixture of dyes. Dyes may be, for example, fluorescent dyes, chromophores or phosphors, among others. Dyes may be used individually and/or in mixtures. By varying the composition of the mixture (i.e. the ratio of one dye to another) and/or the concentration of a wide range of different possible labels can be constructed from a relatively small number of dyes. Suitable exemplary dyes for use in accordance with the present disclosure include, but are not limited to, fluorescent lanthanide complexes, including those of Europium and Terbium, fluorescein, rhodamine, tetramethylrhodamine, eosin, erythrosin, coumarin, methyl-coumarins, pyrene, Malacite green, stilbene, Lucifer Yellow, Cascade Blue™, Texas Red, and others (see, for example, the 1989-1991 Molecular Probes Handbook by Richard P. Haugland).

Linker: As used herein, the term “linker” refers to an entity that acts as a spacer between two other entities that are associated with one another. A linker may provide space between the associated entities such that one or more of the associated entities is not sterically hindered from interacting with another entity. In some embodiments, a linker is cleavable (e.g., chemically cleavable, physically cleavable, etc.). A chemically cleavable bond can be cleaved, for example, by a chemical reaction, change in pH, or an enzymatic reaction. A physically cleavable bond can be cleaved, for example, when some physical change takes place. An example of a chemically cleavable linker is one that contains an S—S group so that when reduced by reducing reagent, e.g., 2-mecaptoethanol, the bond is cleaved. An example of a physically cleavable linker is one that is light sensitive and can be photo activated to break the chemical bond. Yet another example is one that contains a heat-labile bond that falls apart as temperature is increased. In some embodiments, a linker may contain a photo-cleavable group such as a 1-(2 nitrophenyl)-ethyl group. In some embodiments, thermally labile linkers may be a double-stranded duplex formed from two complementary strands of nucleic acid, or other thermal labile interactions. Cleavable linkers also include those having disulfide bonds, acid or base labile groups, including among others, diarylmethyl or trimethylarylmethyl groups, silyl ethers,carbamates, oxyesters, thioesters, thionoesters, and a-fluorinated amides and esters. Enzyme-cleavable linkers can contain, for example, protease-sensitive amides or esters, P-lactamase-sensitive P-lactam analogs, thrombin cleavage sequence, enterokinase cleavage sequence and linkers that are nuclease-cleavable, or glycosidase-cleavable.

Long oligosaccharide: For purposes of the present disclosure, an oligosaccharide is typically considered to be “long” if it includes at least one linear chain that has at least four saccharide residues.

Non-natural amino acid: The phrase “non-natural amino acid” refers to an entity

having the chemical structure of an amino acid (i.e.,:

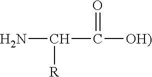

and therefore being capable of participating in at least two peptide bonds, but having an R group that differs from those found in nature. In some embodiments, non-natural amino acids may also have a second R group rather than a hydrogen, and/or may have one or more other substitutions on its amino or carboxylic acid moieties.

Optical signature: An “optical signature”, as that term is used herein, is an optical signal, or set of signals associated with an entity (e.g., with a particle or a particle-glycan). In some embodiments, an optical signal is or comprises one or more of a fluorescent signal, a chemiluminescent signal, a digitally readable bar code, etc.

Polypeptide: A “polypeptide”, generally speaking, is a string of at least two amino acids attached to one another by a peptide bond. In some embodiments, a polypeptide may include at least 3-5 amino acids, each of which is attached to others by way of at least one peptide bond. Those of ordinary skill in the art will appreciate that polypeptides sometimes include “non-natural” amino acids or other entities that nonetheless are capable of integrating into a polypeptide chain, optionally.

Pure: As used herein, an agent or entity is “pure” if it is substantially free of other components. For example, a preparation that contains more than about 90% of a particular agent or entity is typically considered to be a pure preparation. In some embodiments, a pure agent or entity makes up at least 91%, 92%, 93%, 94%, 95%, 96%, 97%, 98%, 99% or more of a given sample.

Short oligosaccharide: For purposes of the present disclosure, an oligosaccharide is typically considered to be “short” if it has fewer than 4, or certainly fewer than 3, residues in any linear chain.

Specific binding: As is known in the art, “specific binding” refers to an interaction between two binding entities that discriminate between possible binding partners. A specific binding interaction is one that occurs in the presence of other entities, e.g., potentially competitive binding partners.

Therapeutic agent: As used herein, the phrase “therapeutic agent” refers to any agent that elicits a desired pharmacological effect when administered to an organism. In some embodiments, an agent is considered to be a therapeutic agent if it demonstrates a statistically significant effect across an appropriate population. In some embodiments, the appropriate population may be a population of model organisms.

Treatment: As used herein, the term “treatment” refers to a therapeutic protocol that alleviates, delays onset of, reduces severity or incidence of, or yield prophylaxis of one or more symptoms or aspects of a disease, disorder, or condition. In some embodiments, treatment is administered before, during, and/or after the onset of symptoms.

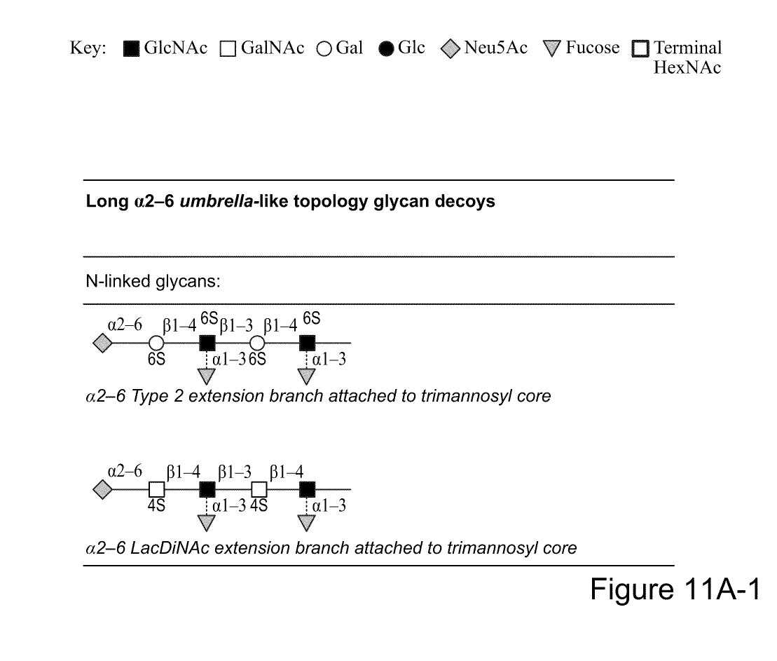

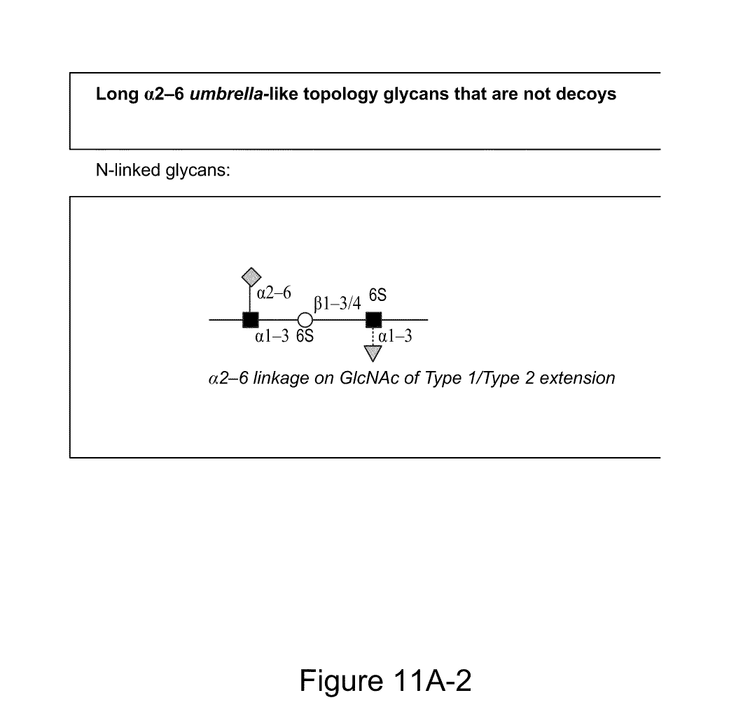

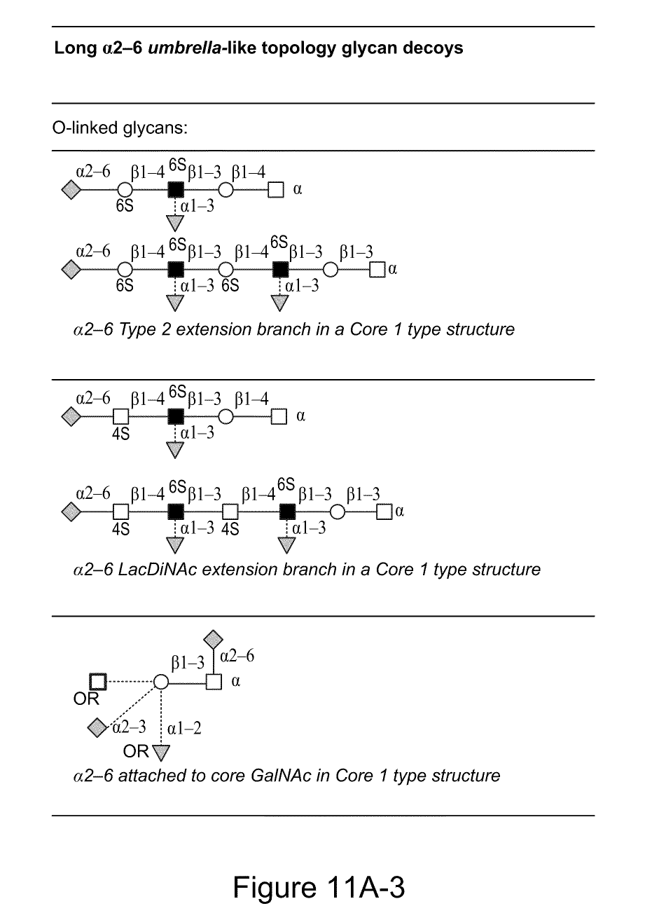

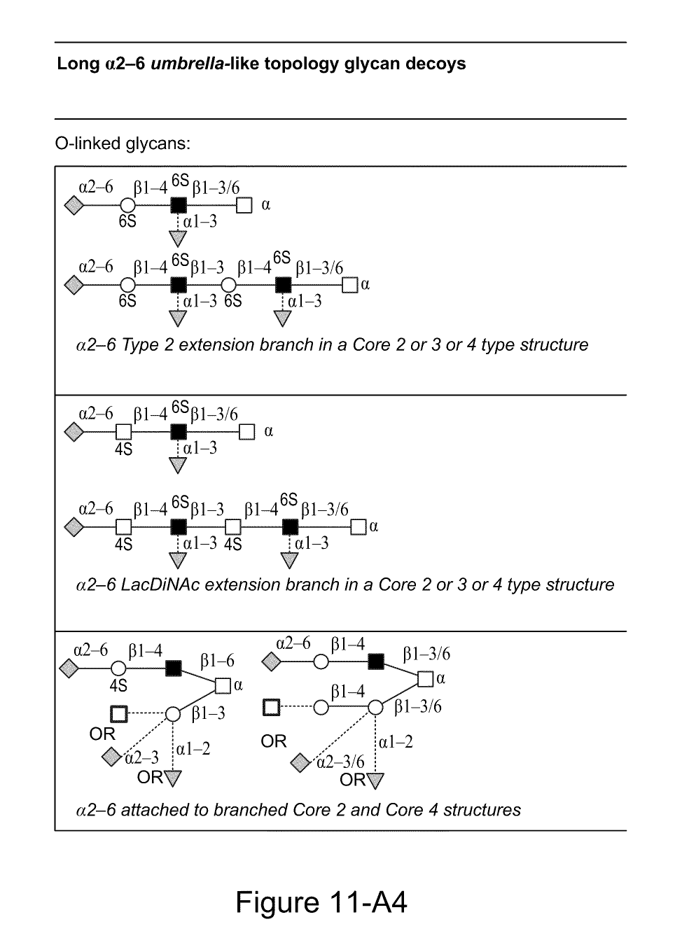

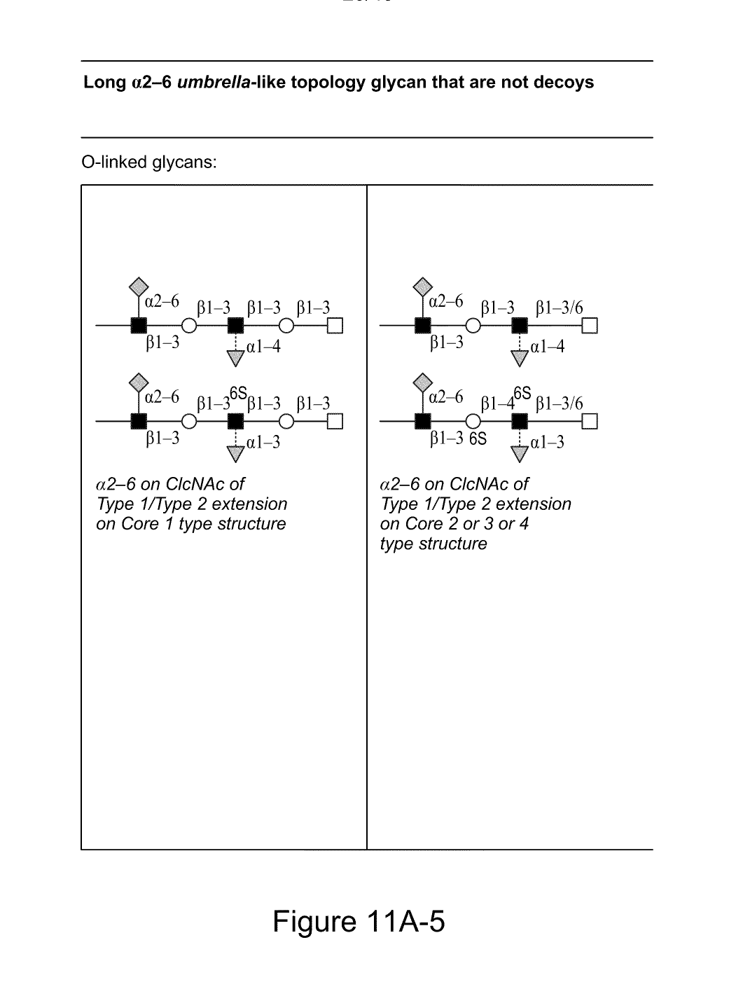

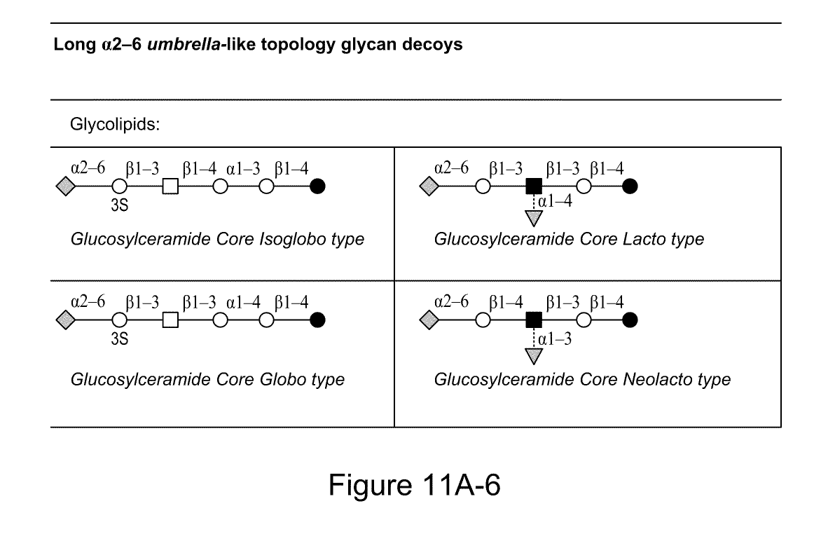

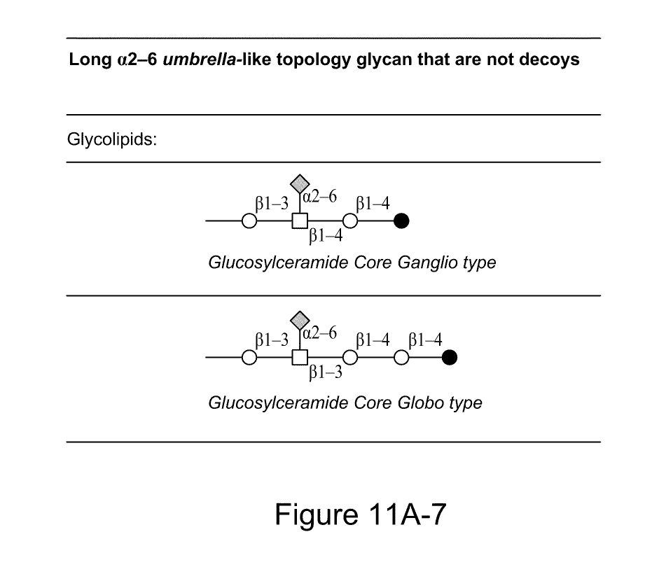

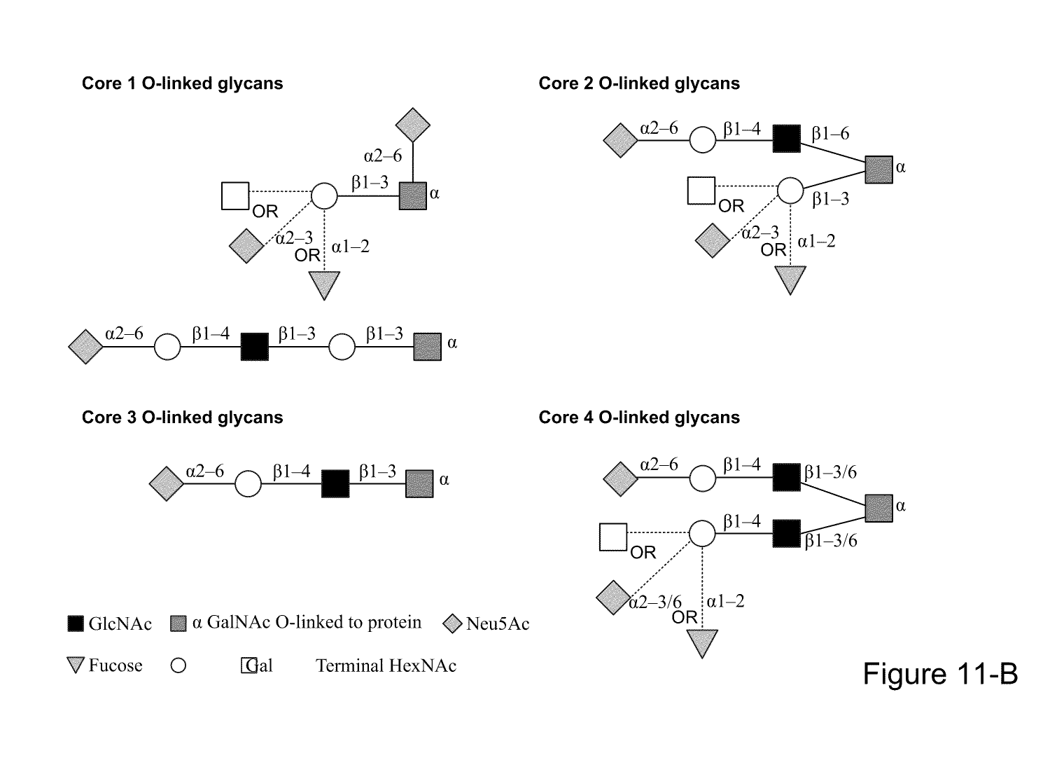

Umbrella topology: The phrase “umbrella topology” is used herein to refer to a 3-dimensional arrangement adopted by certain glycans and in particular by glycans on HA receptors. As noted herein, binding to umbrella topology glycans is characteristic of HA proteins that mediate infection of human hosts. As illustrated in FIG. 8, the umbrella topology is typically adopted only by α2-6 sialylated glycans, and is typical of long (e.g., greater than tetrasaccharide) oligosaccharides. An example of umbrella topology is given by ₄ angle of Neu5Acα2-6Gal linkage of around −60 (see, for example, FIG. 9). FIG. 11 presents certain representative (though not exhaustive) examples of glycans that adopt an umbrella topology.

Vaccination: As used herein, the term “vaccination” refers to the administration of a composition intended to generate an immune response, for example to a disease-causing agent. For the purposes of the present invention, vaccination can be administered before, during, and/or after exposure to a disease-causing agent, and in certain embodiments, before, during, and/or shortly after exposure to the agent. In some embodiments, vaccination includes multiple administrations, appropriately spaced in time, of a vaccinating composition.

Variant: As used herein, the term “variant” is a relative term that describes the relationship between a particular polypeptide of interest and a reference polypeptide to which its sequence is being compared. A polypeptide of interest is considered to be a “variant” of a reference polypeptide if the polypeptide of interest has an amino acid sequence that is identical to that of the reference but for a small number of sequence alterations at particular positions. In some embodiments, a variant will show a high level of overall sequence identity with the reference polypeptide. In some embodiments, a variant will show an overall sequence identity of at least 50%, 55%, 60%, 65%, 70%, 75%, 80%, 85%, 90%, 91%, 92%, 93%, 94%, 95%, 96%, 97%, 98%, 99% or higher with the reference polypeptides. In some embodiments, in addition to the overall level of sequence identity, a variant will show a still higher level of sequence identity across one or more characteristic sequence elements found in the reference polypeptide. Typically, fewer than 20%, 15%, 10%, 9%, 8%, 7%, 6%, 5%, 4%, 3%, 2% of the residues in the variant are substituted as compared with the reference polypeptide, or at least with the characteristic sequence element in the reference polypeptide. In some embodiments, a variant has 10, 9, 8, 7, 6, 5, 4, 3, 2, or 1 substituted residue as compared with a parent its characteristic sequence element. Often, a variant has a very small number (e.g., fewer than 5, 4, 3, 2, or 1) number of substituted functional residues (i.e., residues that participate in a particular biological activity). Furthermore, a variant typically has not more than 5, 4, 3, 2, or 1 additions or deletions, and often has no additions or deletions, as compared with the parent. Moreover, any additions or deletions are typically fewer than about 25, 20, 19, 18, 17, 16, 15, 14, 13, 10, 9, 8, 7, 6, and commonly are fewer than about 5, 4, 3, or 2 residues. A variant may be included in a fusion polypeptide, in which the variant is covalently linked with a heterologous polypeptide moiety of 10 or more amino acids in length.

Vector: As used herein, the term “vector” refers to a nucleic acid molecule capable of transporting another nucleic acid to which it has been linked. In some embodiment, vectors are capable of extra-chromosomal replication and/or expression of nucleic acids to which they are linked in a host cell such as a eukaryotic or prokaryotic cell. Vectors capable of directing the expression of operatively linked genes are referred to herein as “expression vectors.”

Wild type: As is understood in the art, the phrase “wild type” generally refers to a normal form of a protein or nucleic acid, as is found in nature. For example, wild type HA polypeptides are found in natural isolates of influenza virus. A variety of different wild type HA sequences can be found in the NCBI influenza virus sequence database, http://www.ncbi.nlm.nih.gov/genomes/FLU/FLU.html.

### DETAILED DESCRIPTION OF CERTAIN EMBODIMENTS OF THE INVENTION

### Classification of Microbes

Significant effort is dedicated worldwide to the classification of microorganisms, and in particular of viruses. Typically, microorganisms are classified into subtypes based on similarities or differences in nucleic acid and/or protein sequences. The present invention encompasses the recognition of certain problems in relying solely on sequence-based classifications to establish microorganism subtypes. Among other things, the present invention recognizes that appreciation of functional differences between microorganism isolates, rather than or in addition to sequence differences, would provide important and useful information relevant to the detection and control of microorganisms, for example that present particular potential risks or benefits to a population.

To give but one example, influenza viruses are a significant cause of morbidity and mortality worldwide (see, for example, Miller et al N Engl J Med 360: 2595, 2009; Morens, et al., N Engl J Med 361:225, 2009). Besides the seasonal influenza epidemics caused by H1N1 and H3N2 influenza virus strains, new strains of influenza virus emerge periodically with pandemic potential. Extensive systems are in place to monitor influenza virus sequence evolution (e.g., through mutation and recombination). However, public health laboratories still fail to detect novel strains of influenza and, importantly, to differentiate those that are primarily animal-adapted from those with true pandemic potential. For example, the advent of the 2009 H1N1 “swine flu” pandemic (see, e.g., Dawood et al. N Engl J Med 360:2605, 2009) highlighted a gap in the ability of existing strategies to detect and characterize emerging strains before the widespread onset of disease in the population. Early detection of virus strains with pandemic potential is important, as it allows prompt mobilization of efforts to stockpile sufficient quantities of vaccines and therapeutic agents to limit the spread of the disease.

One of the challenges in detecting emerging microorganism strains is that factors leading to the generation of pandemic variants are typically complex and are currently poorly understood. In general, it is believed that for a virus to have pandemic potential, it will be capable of human-to-human aerosol transmission. Furthermore, it is typically expected that truly pandemic strains will be those for a substantial population exists that is immunologically naïve to the strain (see, e.g., Steel, et al. J Virol 84:21, 2010). Poor human-to-human transmissibility of

H5N1 “avian flu”, for example, seems to be the major impediment to more serious outbreaks (e.g., Maines, et al. Proc Natl Acad Sci USA 103:12121, 2006; Maines, et al. Science 325:484, 2009). These basic issues are not limited to influenza viruses, of course, but have recently been prominently illustrated in that context.

The development of aerosol transmissibility in influenza viruses involves changes in the influenza hemagglutinin (HA) protein (see, e.g., Srinivasan, et al. Proc Natl Acad Sci USA 105:2800, 2008). HA binding to cell surface glycans present on cells of the upper respiratory tract is the initial step in viral infection; indeed, HA has been found to be an important viral gene involved in infectivity and transmission (see, e.g., Chandrasekaran et al. Nat Biotechnol 26:107, 2008). Furthermore, a comprehensive study of HA-glycan interaction of seasonal and pandemic influenza strains has revealed that the high-affinity binding of HA to sialic acid linked glycans with a distinct structural topology, is an important step in efficient human-to-human transmission (see, for example U.S. Patent Publication Nos. 20100061990, 20100004195, 20090269342, 20090081193, 20080241918, Chandrasekaran et al. Nat Biotechnol 26:107, 2008, and Srinivasan, et al. Proc Natl Acad Sci USA 105:2800, 2008).

The present invention encompasses the recognition that current surveillance methods, which typically involve genotyping of viral isolates to identify type and subtype, and/or comparing the antigenicity of newly identified strains with that of existing strains, do not directly assess the important functional binding attributes of HA proteins that are relevant, for example, to the development of human-to-human transmission. The present invention provides, among other things, a system that assesses and characterizes influenza strains based on the affinity of their HA for particular glycans of interest (e.g., umbrella-topology glycans).

Prior work has developed chemically defined glycan arrays in which individual glycans are attached to a single solid support, typically a glass slide, (see, e.g., Alvarez & Blixt Methods Enzymol 415:292, 2006; Blixt, et al. Proc Natl Acad Sci USA 101:1703, 2004; Stevens, et al, Nat Rev Microbiol 4:857, 2006; Wang, et al, Nat Biotechnol 20:275, 2002). Intact viruses, recombinantly expressed HAs, and certain HA variants from H1, H3, and H5 subtypes have been analyzed using glycan arrays, typically to provide a binary (yes/no) determination of whether the virus, HA, or variant binds directly to individual glycans on the array (see e.g., Stevens et al., J Mol Biol 355:1143, 2006). Such studies can provide high-quality binding data.

However, the present invention encompasses the recognition of certain disadvantages of these arrays. Moreover, the present invention appreciates surprising benefits of alternative array formats, and provides arrays that are, among other things, modular, inexpensive to produce, easy to assemble and to adapt to changing information, and/or amenable to the provision of quantitative, rather than merely binary, binding data. Among other things, the present invention appreciates that glycan arrays in which glycans are affixed (typically by molecular printing with expensive high-precision equipment) are costly to produce and rigid in their manufacture; once an array has been produced, the representation of glycans within the array (i.e., addition or subtraction of individual glycan species and/or adjustment of relative representation of species) cannot be changed. According to the present invention, such arrays are not readily adaptable to changing information, or to presentation of custom formats.

### Particulate Glycan Arrays

The present invention provides arrays in which individual glycans of interest, or predetermined sets of glycans, are separately attached to individual solid supports. Collections of solid supports can then be assembled by mixing selected amounts of the individual supports. The term “Particulate Array”, as used herein, refers to a collection of individual solid supports (or populations thereof), each of which has attached thereto a different glycan (or set of glycans).

In some embodiments, individual glycans, and/or individual supports, are detectably labeled.

Provided particulate arrays may be queried through interaction with a sample that contains a target ligand whose glycan binding characteristics are to be identified and/or assessed. During and/or after such interaction, binding events are detected. In some embodiments, provided particulate arrays are assayed in suspension. In some embodiments, one or more of the interacting and/or detecting steps is performed on particular arrays arranged on a solid surface.

The present disclosure includes exemplification of provided particulate arrays containing glycans found on influenza A receptors. Those of ordinary skill in the art, reading the disclosure, will readily recognize the importance and value of such provided particulate arrays. Those of ordinary skill, reading the present disclosure, will further appreciate that many of the principles and techniques described herein as applied to influenza receptor glycan arrays are readily applicable to other glycan sets, and could be applied to such sets without undue experimentation. The present invention therefore provides a wide range of particulate arrays and array components containing glycans of interest.

To give but a few examples, in some embodiments, a provided particulate array is comprised of a first population of particles associated with at least a first umbrella topology glycan. In some such embodiments, such a provided particulate array is comprised of at least a second population of particles associated with at least a first cone topology glycan and/or at least a third population of particles associates with at least a second umbrella topology glycan. In at least some such embodiments, at least one glycan included in the array is a glycan that is found in human epithelial tissues. In at least some such embodiments, at least one glycan included in the array is a glycan that is found in human epithelial tissues in the human respiratory tract (e.g., upper and/or lower respiratory tract). In some embodiments, a provided particulate array is comprised of populations of particles associated with glycans selected to be representative of types and/or amounts of glycans present in human epithelial tissues, particularly human respiratory tract (e.g., upper and/or lower respiratory tract) tissues.

### Particles

Those of ordinary skill in the art will readily appreciate that any of a variety of different solid support particles may be used in accordance with the present invention. In general, arrays as described herein are comprised of a plurality of populations of solid support particles, each of which is associated with a different glycan (or set of glycans). In general, it will be desirable that the different populations of solid supports be distinguishable from one another. Clearly, they will be distinguishable after they are associated with their relevant glycans. In some embodiments, solid support particle populations will be distinguishable from one another both before and after being associated with glycans. In some embodiments, different populations will be distinguishable from one another based on particle size, particle color, presence of a detectable optical signature or marker, or combinations thereof

To give but a few examples of appropriate particles, those of ordinary skill in the art will appreciate that suitable particles may be comprised of, plastics, ceramics, glass, polystyrene, methylstyrene, acrylic polymers, semiconductor materials (e.g., quantum dots), paramagnetic materials, thoria sol, carbon graphited, titanium dioxide, latex or cross-linked dextrans such as sepharose, cellulose, nylon, cross-linked micelles and teflon (see, for example, “Microsphere Detection Guide” from Bangs Laboratories, Fishers Ind.). A variety of particle materials are known in the art, and attachment technologies, including for glycans, have been developed for many (see, for example, Wang, et al. Exp. Biol. Med. 234, 1128-1139 (2009); Wang et al. Adv. Mater. 22, 1-8 (2010), each of which is incorporated herein by reference in its entirety).

In many embodiments, particles will be substantially spherical in shape. However, those of ordinary skill in the art will appreciate that various shapes may be employed as appropriate to particular applications and/or equipment being utilized. In some embodiments, any collection of discrete physical entities is employed. In some embodiments, at least one population of solid phase particles in an array may be or comprise particles that are irregular and/or elongate and/or that have at least one edge. In some embodiments, different populations within an array are or comprise particles of different shape. In some embodiments, all populations within an array are or comprise particles of the same shape.

In some embodiments, at least one population of solid phase particles in a provided array may be or comprise particles that are porous. In some embodiments, different populations within an array are or comprise particles of different porosity. In some embodiments, all populations within an array are or comprise particles of the same (or comparable) porosity.

In some embodiments at least one population of solid phase particles in a provided array may be or comprise particles whose size is within the range of nanometers to millimeters. In some embodiments, different populations within an array are or comprise particles of different size. In some embodiments, all populations within an array are or comprise particles of the same (or comparable) size.

Those of ordinary skill in the art will appreciate that particles utilized in accordance with the present invention may be functionalized, for example with any of a variety of chemical groups (e.g., (e.g., —COOH, -tosyl, -epoxy etc.). In some embodiments, functional groups may be used to form covalent bonds that associate glycans with the particles. In some embodiments, glycans themselves become covalently attached to the particles. In some embodiments, an attachment agent is covalently attached to the particles, which attachment agent either binds directly to the relevant glycans or binds to an interaction partner that is attached to (or otherwise associated with) the glycans. For example, in some embodiments, streptavadin and biotin are used as attachment agent and interaction partner; those of ordinary skill in the art will be aware of a wide variety of attachment agents and/or of attachment agent/interaction partner pairs that can appropriately be utilized in accordance with the present invention.

In some embodiments, different populations of particles in a provided array may differ from one another at least by the presence of a different attachment agent on particles in different populations. Such an approach permits advance preparation of a set of particle populations that are distinguishable from one another, at least based on attachment agent, prior to association with any glycans. This same set of particle populations can thus be used in the assembly of any of a variety of provided glycan arrays, as any set of glycan populations can be associated with appropriate interaction partners to be linked with a particular population of particles. In some embodiments, particle populations distinguishable from one another based on attachment agent are also distinguishable from one another based on at least one additional feature (e.g., size, shape, detectable label, etc.).

In some embodiments, all populations of particles in a provided array are associated with the same attachment agent.

Particles for use in accordance with the present invention may be labeled. In some embodiments, different populations of particles in a provided array may differ from one another at least by the presence of a different label on particles in different populations. In some such embodiments, the different populations also differ from one another in at least one further aspect (e.g., color, size, shape, attachment agent, etc). In some embodiments, all populations of particles in a provided array are similarly labeled.

Particles may be labeled by association (e.g., covalent or non-covalent) of a label with a particle and/or by fabrication of the label into particles (e.g., by entrapping a dye or printing a bar code, etc).

### Glycans

As described above, those of ordinary skill in the art, reading the present disclosure, will appreciate that the present invention provides a wide range of particulate arrays and array components containing glycans of interest. Glycans for use in accordance with the present invention may be obtained from any of a variety of sources. In some embodiments, glycans of interest are synthetic glycans. In some embodiments, glycans of interest are prepared from a biological sample (e.g., one or more cell types, tissues, and/or fluids). In some embodiments, glycans of interest comprise one or more glycosaminoglycans (e.g., hyaluronic acid, dermatan sulfate, chondroitin sulfate, heparin, heparan sulfate, keratan sulfate, etc.).

It will be appreciated that preparation of glycans from a biological sample may include treatment of the sample with an agent (e.g., chemical agent, enzyme, etc.). In some embodiments, glycan-containing samples may be treated with a glycosidase or a combination of glycosidases (e.g., sialidase, galactosidase, hexosaminidase, fucosidase, and/or mannosidase).

In some embodiments, particulate arrays in accordance with the present invention contain glycans found in a particular organism, cell type, and/or tissue type. In some embodiments, particulate arrays in accordance with the present invention contain glycans from more than one organism, cell type and/or tissue type.

In some embodiments, particulate arrays in accordance with the present invention contain glycans prepared by synthesis. In some embodiments, particulate arrays in accordance with the present invention contain glycans prepared by isolation from a biological source. In some embodiments, particular arrays in accordance with the present invention contain both synthetic and isolated glycans.

In some embodiments, particulate arrays in accordance with the present invention contain naturally-occurring glycans. In some embodiments, particulate arrays in accordance with the present invention contain non-naturally-occurring glycans. In some embodiments, particulate arrays in accordance with the present invention include both naturally-occurring and non-naturally-occurring glycans.

Those of ordinary skill in the art will be aware that the Consortium for Functional Glycomics (CFG; www.functionalglycomics.org), an international collaborative research initiative, has developed glycan arrays comprising both synthetic glycans that capture the physiological diversity of N- and O-linked glycans as well as N-linked glycan mixtures derived from different mammalian glycoproteins.

In many embodiments, it will be desirable to select glycans for provided arrays that together provide a set that can be used to identify, detect, and/or characterize microorganisms having one or more such attributes of interest. Such attributes may include, for example, transmissibility of, morbidity caused by, and/or therapeutic responsiveness or resistance of, etc, different defined microorganism subtypes.

### Interrogation of Particulate Glycan Arrays

In general, particulate glycan arrays as described herein are interrogated through contact with a sample known or suspected to contain a glycan binding agent.

In some embodiments, particulate glycan arrays are interrogated through contact with a sample known to contain a glycan binding agent such that glycan binding characteristics of the glycan binding agent are determined. In some embodiments, particulate glycan arrays are interrogated through contact with a sample not known to contain a glycan binding agent, such that presence of the binding agent (or of a glycan binding agent having particular pre-determined glycan binding attributes) is determined. Thus, in some embodiments, provided particulate glycan arrays are used to characterize glycan binding agents. In some embodiments, provided particulate glycan arrays are used to detect glycan binding agents.

Those of ordinary skill in the art will appreciate that any of a variety of samples may be utilized to interrogate particulate glycan arrays as described herein. In some embodiments, a sample is or is isolated from an environmental sample. In some embodiments, a sample is or is isolated from tissue of an organism (whether living or dead). In some embodiments, a sample is or is isolated from bodily fluid (e.g., blood, urine, sweat, tears, mucus, etc) of an organisms (e.g., a bird or a mammal, e.g., a farm animal or human). In some embodiments, a sample is or contains bird (e.g., chicken) excrement. In some embodiments, a sample is or contains bird tissue or tissue components. In some embodiments, a sample is or contains animal (e.g., horse, cow, goat, sheep, pig, dog, cat, ape, human, etc) excrement. In some embodiments, a sample is or contains animal tissue or tissue components. In some embodiments, a sample is or contains soil or components of soil.

Particles and sample may be contacted with one another in any format that permits assessment of binding interactions as described herein. In many embodiments, different particle populations are combined with one another prior to being contacted with the sample. In some embodiments, different particle populations are contacted separately with the sample.

In some embodiments, particles and sample are contacted with one another in solution/suspension. In some embodiments, binding events that occur between glycan-particles in the array and glycan binding agents in the sample are detected in solution/suspension. As will be clear to those of ordinary skill in the art, any of a variety of assay and readout formats may be utilized. In some embodiments, flow cytometry analysis is utilized to sort bound and unbound particles. Flow cytometry methods are generally known in the art.

In some embodiments, after binding has occurred, particles are distributed on a substrate, and the substrate is interrogated to determine positions and/or identities of glycan-particles to which a glycan binding agent has bound.

In some embodiments, binding of glycan binding agents to glycans on particles is assessed as a binary event; in some embodiments affinity is quantified.

### Microorganisms

Those of ordinary skill in the art will well appreciate that provided particulate glycan arrays can be used in the analysis of any microorganism for which fact and/or degree of glycan binding is relevant to a functional attribute of interest.

In some embodiments, the microorganism is a virus. Exemplary viruses include, but are not limited to, Adenoviruses, Arboviruses, Astroviruses, Bacteriophages, Enteroviruses, Gastroenteritis Viruses, Hantavirus, Coxsackie viruses, Hepatitis A Viruses, Hepatitis B Viruses, Hepatitis C Viruses, Herpesviruses (for example, Epstein Barr Virus (EBV), Cytomegalovirus (CMV) and Herpes Simplex Virus (HSV)), Influenza Viruses, Norwalk Viruses, Polio Viruses, Chordopoxyiridae (i.e., 5 Orthopoxvirus, vaccinia, MVA, NYVAC, Avipoxvirus, canarypox, ALVAC, ALVAC(2), fowlpox, Rhabdoviruses, Reoviruses, Rhinoviruses, Rotavirus, Retroviruses, Baculoviridae, Caliciviridae, Caulimoviridae, Coronaviridae, Filoviridae, Flaviviridae, Hepadnaviridae, Nodaviridae, Orthomyxoviridae, Paramyxoviridae, Papovaviridae, Parvoviridae, Phycodnaviridae, Picornaviridae, and Togaviridae, and modified viruses originating from, based upon, or substantially similar to any of the foregoing or other suitable virus. In some embodiments, the virus is an influenza virus.

In some embodiments, the microorganism is a bacteria (e.g., gram positive or gram negative bacteria). Exemplary gram positive bacteria include, but are not limited to Staphylococcus aureus, Staphylococcus epidermidis, S. haemolyticus, S. hominis, S. exotoxin and S. saprophyticus, Streptococcus pyogenes, Streptococcus pneumoniae, Streptococcus agalactia, Streptococcus mutans, E. faecium, E. faecalis, E. avium, E. casseliflavus, E. durans, E. gallinarum, E. dispar, E. hirae, E. flavescens, E. mundtii, E. solitarius, E. rqffinosus, Peptostreptococcus magnus, Peptostreptococcus asaccharolyticus, Peptostreptococcus anaerobius, Peptostreptococcus prevotii, Peptostreptococcus micros, Veillonella, S. sobrinus, S. salivarius and S. vestibularis, S. bovis, S. sanguis, S. gordonii, S. mitis, S. oralis, S. anginosus, S. constellatus, S. intermedius, S. milleri, S. MG-intermedius, S. anginosus-constellatus; Abiotrophia, Granulicatella, Gemella haemolysans, Gemella morbillorum, Gemella bergeriae, Gemella sanguinis, Rothia mucilaginosa; Aerococcus viridans, A. urinae, L. lactis, L. s garviae, Helcococcus kunzii, Globicatella sanguis, Facklamia; Ignavigranum, Dolosicoccus, Dolosigranulum pigrum, A. otitidis, V. fluvialis and V. salmoninarum, L. citreum, L. lactis, L. mesenteroides, L. pseudomesenteroides, L. argentinum, L. parames enter oides, P. acidilactici, P. pentosaceus, Tetragenococcus halophilus, Lactobacillus sp., L. acidophilus, Clostridium botulinum, Clostridium botulinum, Clostridium perfringens, Clostridium tetani); Actinomyces sp., A. israeli), Bifidobacterium, B. dentium, Nocardia sp., Listeria monocytogenes, Corynebacterium diptheriae, Propionibacterium acnes; Bacillus anthracis, and Erysipelothrix rhusiopathiae. Exemplary gram negative bacteria include, but are not limited to, K. pneumoniae, Citrobacter, S. marascens, Enterobacter, P. mirabilis, P. vulgaris, P. myxofaciens, M. morganii, P. rettgeri, P. alcalifaciens, P. stuartii, Salmonella sp., S. typhi, S. paratyphi A, B S. schottmuelleri, S. hirschfeldii, S, enteritidis, S. typhimurium, S. heidelberg, S. newport, S. infantis, S. agona, S. montevideo, and S. saint-paul, S. fiexneri, S. sonnei, S. boydii, S. dysenteriae, H. influenzae, Brucella abortus, B. melitensis, B. suis, B. canis, Francisella tularensis, V. cholerae, V. parahaemolyticus, V. mimicus, V. alginolyticus, V. hollisae, V. vulnificus, Y. pestis, Y. enterocolitica, B. pseudornallei, B. cepacia, C. fetus, C. jejuni, C. coli, Helicobacter pylori; Acinetobacter baurnannii, Actinobacillus actinomycetemcomitans, Bordetella pertussis; Capnocytophaga; Cardiobaeteriurn hominis, Eikenella corrodens, Kingella kingii, Legionella pneumophila, Pasteurella multisided, Acinetobacter sp., Xanthomonas; maltophilia: Aeromonas; Plesiomonas shigelloides, N. gonorrhoeae N. meningitides, Moraxella (Branhamella) catarrhalis, and Veillonella parvula.

In some embodiments, the microorganism is a fungus. Exemplary fungi include, but are not limited to C. albicans, H. capsulatum, A. fumigatus, C. neoformans, C. purpurea, P. jirovecii, S. schenckii, T. rubrum, T. mentagrophytes, M. furfur, C. immitis, B. dermatiditis, E. wernickii, P. hortaw, and T. beigelii.

### EXEMPLIFICATION

### Example 1

### Glycan Microarrays for Functional Characterization of Influenza Viruses

The present Example describes a particulate array comprised of at least two populations of solid phase particles associated with glycans, and further describes its use with respect to influenza viruses and HA polypeptides.

### Introduction

The ongoing global efforts to control influenza epidemics and pandemics require high throughput technologies to detect, quantify, and functionally characterize viral isolates. High affinity binding of the virus hemagglutinin (HA) to human receptor glycans is a highly sensitive and stringent indicator of human transmissibility. In this example, we demonstrate a particle-based glycan microarray that is modular, easy to assemble, and suitable for high throughput screens. This approach offers an inexpensive field alternative to the printed microarrays that can be readily reassembled to express any informative glycan cluster.

Influenza viruses are a significant cause of morbidity and mortality worldwide (see, for example, Miller, M. A., Viboud, C., Balinska, M. & Simonsen, L. N Engl J Med 360, 2595-8 (2009); Morens, D. M., Taubenberger, J. K. & Fauci, A. S. N Engl J Med 361, 225-9 (2009)). Besides the seasonal influenza epidemics caused by H1N1 and H3N2 influenza virus strains, new strains of influenza virus emerge periodically with pandemic potential. Despite the extensive network in place to monitor influenza virus evolution through mutation and recombination, public health laboratories still fail to detect novel strains of influenza and differentiate those that are primarily animal-adapted from those with true pandemic potential. For example, the advent of the 2009 H1N1 “swine flu” pandemic (see, e.g., Dawood, F. S. et al. N Engl J Med 360, 2605-15 (2009)) highlighted a gap in our ability to detect and characterize emerging strains before the widespread onset of disease in the population. Early detection of virus strains with pandemic potential is important, as early detection of an outbreak is important to generate and stockpile sufficient quantities of vaccines and anti-virals to limit the spread of the disease.

One of the challenges in detecting emerging strains is that the factors leading to the generation of a pandemic virus are complex and poorly understood. At a functional level, however, it is thought that for a virus to have pandemic potential, it will be capable of human-to-human aerosol transmission and there will exist a substantial population that is immunologically naïve to the strain of virus (see, e.g., Steel, J. et al. J Virol 84, 21-6 (2010)). Poor human-to-human transmissibility of H5N1 “avian flu”, for example, seems to be the major impediment to more serious outbreaks (e.g., Maines, T. R. et al. Proc Natl Acad Sci USA 103, 12121-6 (2006); Maines, T. R. et al. Science 325, 484-7 (2009)). Therefore, development of assays that identify subtypes (or mutants) that have the potential to make the jump to humans from animal reservoirs is important for disease surveillance and public health. We have previously elucidated the role of the influenza hemagglutinin (HA) in aerosol transmissibility (e.g., Srinivasan, A. et al. Proc Natl Acad Sci USA 105, 2800-5 (2008)). HA binding to cell surface glycans present on cells of the upper respiratory tract is the initial step in viral infection; indeed, HA has been found to be an important viral gene involved in infectivity and transmission (e.g., Chandrasekaran, A. et al. Nat Biotechnol 26, 107-13 (2008)). Furthermore, a comprehensive study of HA-glycan interaction of seasonal and pandemic influenza strains has revealed that the high-affinity binding of HA to α2-6 sialic acid linked glycans with a distinct structural topology, is an important step in efficient human-to-human transmission.

Current surveillance methods include genotyping of viral isolates using PCR to identify their type and subtype, as well as comparing the antigenicity of newly identified virus subtypes to existing strains. Despite comprehensive genotypic and phenotypic analyses, it is often difficult to functionally type the virus. Given the observed correlation between high affinity binding to α2-6 sialylated glycan receptors and efficient transmission, we reasoned that a surveillance strategy involving the typing of virus strains, and more specifically, viral HAs based on their affinity to these glycans would provide a robust methodology to detect and type the transmissibility of emerging strains.

Traditionally, receptor specificities of avian- and human-adapted influenza viruses are determined using a red blood cell (RBCs) agglutination assay. RBCs from species such as chicken, turkey, horses, guinea pigs and humans have been used in such assays (e.g., Connor, R. J., Kawaoka, Y., Webster, R. G. & Paulson, J. C. Virology 205, 17-23 (1994); Tumpey, T. M. et al. Science 315, 655-9 (2007)). RBCs have also been used in conjunction with sialidases and sialyltransferase to present certain glycan structures, for example ones which exclusively contain either α2-3 or α2-6 linked sialic acid (e.g., Paulson, J. C. & Rogers, G. N. Methods Enzymol 138, 162-8 (1987); Suptawiwat, O. et al. J Clin Virol 42, 186-9 (2008)). This type of assay however is inherently limited in that it fails to account for receptor specificity beyond the sialic acid linkage. Moreover, it has been recently shown that the sialylated glycans on RBCs are significantly different from the glycan on the upper respiratory tract of humans (e.g., Srinivasan, A. et al. Proc Natl Acad Sci USA 105, 2800-5 (2008); Chandrasekaran, A. et al. Nat Biotechnol 26, 107-13 (2008)). Other methods such as fetuin capture assays suffer from the same limitation (e.g., Gambaryan, A. S. & Matrosovich, M. N. J Virol Methods 39, 111-23 (1992)).

The advent of chemoenzymatic synthesis strategies for glycans and development of glycan array platforms has enabled the study of HA specificity using chemically defined glycans (e.g., Alvarez, R. A. & Blixt, O. Methods Enzymol 415, 292-310 (2006); Blixt, O. et al. Proc Natl Acad Sci USA 101, 17033-8 (2004); Stevens, J., Blixt, O., Paulson, J. C. & Wilson, I. A. Nat Rev Microbiol 4, 857-64 (2006); Wang, D., Liu, S., Trummer, B. J., Deng, C. & Wang, A. Nat Biotechnol 20, 275-81 (2002)). Intact viruses, recombinantly expressed HAs, and their mutant forms from H1, H3, and H5 subtypes have been analyzed using glycan arrays (e.g., Stevens, J. et al. J Mol Biol 355, 1143-55 (2006)). While high-quality binding data can be obtained using such arrays, they do not readily lend themselves as a routine tool for virus surveillance due to three major factors: first, the microarrays are synthesized by molecular printing on glass slides using high-precision equipment, and are still costly to manufacture; second, the glycans are covalently bound to the glass, making the array irreversibly rigid and thus not suitable for rapid construction of a custom-made array; and third, typical array formats are interpreted in an on/off manner, rather than through a quantitative readout, thus missing potentially critical information.

In this Example, we present an alternative to the planar glycans array using polystyrene microparticles as a flowing matrix for a modular glycan array. Suspension arrays of microparticles offer many advantages, e.g., higher flexibility, faster reaction kinetics and greater sensitivity owing to the three-dimensional presentation of glycans. Flow cytometry enables automated, large-scale sample screening. Using custom designed glycomicroparticles, we have developed an assay platform for high-throughput functional characterization of influenza virus based on their ability to bind to α2-6 sialylated glycans with high affinity.

### Methods

Microparticle Preparation and Quantitative Flow Cytometry: Biotinylated N-glycans were mounted on streptavidin functionalized polystyrene particles (Polysciences, nominal diameter 6.018 μm) according to the manufacturer's instructions, at a final glycan concentration of 660 attomol/particle, by incubation in binding buffer (0.2 M PO₄, 0.15 M NaCl, 1% w/v BSA, pH 7.4; maximal volume 25 μL) for 1 h at room temperature, followed by washing with binding buffer. Quantitative flow cytometry was performed on a Beckman-Coulter Cell Lab Quanta SC flow cytometer equipped with automated MPL robot, a 488 nm argon laser and a 366/405/435 nm mercury arc UV source. Fluorescence surface density calibration was performed using Quantum™ MESF FITC reference kit (Bangs Labs, Fishers, Ind.) according to the manufacturer's instructions, acquiring at least 3 independent times per each MESF level at various photomultiplier voltages (0.3 V increments).

Lectins, Viral Hemagglutinins and Fluorescent Labeling: Fluorescently-labeled SNA-I lectin was purchased from Vector Labs. Soluble wildtype H1/SC18 was expressed in a baculovirus system as previously described. A/California/04/09, A/Wyoming/3/03 and A/Vietnam/1203/04 HA (Protein Sciences Inc.) and MAL-II (Vector Labs) were labeled with FITC (Thermo). For labeling, FITC was dissolved in dimethylformamide (5 mg/mL) and added to the protein solution (in 0.2 mL PBS) to yield a FITC:protein molar excess of 20. After 1 hr incubation at room temperature in the dark, labeled proteins were cleaned by centrifugal gel filtration (30,000 Da nominal cutoff), two sequential rounds of washing with PBS on a Vivaspin column according to the manufacturer's instructions. Fluorescein contents (mol/mol protein) in the probing proteins were measured by spectrophotometry at A280/A495.

Biotinylation of LSTc and LSTa: Ez-linked Biotin hydrazide (4.6 mg) was dissolved in 70 μL of dry dimethyl sulfoxide (DMSO) in room temperature, heated to 65° C. to dissolve completely for 1-2 min. Glacial Acetic acid (30 μL) was added to the glass vial containing soluble biotin hydrazide. The total solution was added to another vial containing 6.4 mg of sodium cyanoborohydride and dissolved at room temperature and subsequently heated slightly at 65° C. to dissolve completely. 10 μL of solution was added to about 50 μg of dried free glycans. The glycans and labeling reagents were mixed and incubated for 3 h at 65° C. After completion of reactions, the samples were purified by pre-equilibrated GlykoClean G Cartridge (Prozyme Cat. #GC250-6) (Equilibrated by washing once with 4×1 mL of acetonitrile and 4×1 mL of mili-Q water). Briefly, after reaction, the labeled glycans were re-suspended in 300 μL of 96% acetonitrile/mili-Q water. The entire substance was added to the pre-equilibrated column and eluted. Subsequently the column was washed with 96% acetonitrile/mili-Q water (6×1 mL) and the product was eluted with mili-Q water (6×1 mL). After successful elution by gravity methods the entire eluent was lyophilized and reconstituted in 400 μL, then 40 μL of water. The glycans were further purified to remove excess biotin by HPLC (GLYCOSEPTM N HPLC column obtain from Prozyme, in gradient 3) using 50 mM ammonium formate pH 4.4 / acetonitrile as eluent. Finally LC-linked Biotin labeled N-glycans were characterized by analytical tools described below.

Glycan MS Analysis by MALDI-MS Spectroscopy: All glycans were analyzed using the Voyager DE-STR MALDI-TOF MS (Applied Biosystems). Acidic glycans were analyzed using 10 mg/mL ATT in ethanol. The purified sample can be diluted in a number of different volumes depending on the starting amount. The sample and matrix was combined in a 1:9 ratio, respectively. Nafion (1 μl) was spotted on the plate and allowed to dry for ˜5 minutes. The matrix-sample mixture was then spotted on top of the Nafion spot and allowed to dry in a humidity chamber (humidity 23%). The following parameters were used for acidic glycan analysis: Negative and Linear Mode, 22,000V Accelerating Voltage, 93% Grid Voltage, 0.3% Guide Wire, 150 nsec Delay. The calibrated mass value of the MALDI MS spectra for the biotin labeled LSTa and LSTc are well matched with the expected mass as shown in the supplementary figure S3.

Quantitative Estimation of Sialic acid and Total Sialic acid Linked N-Glycans from Biotinylated LSTc and LSTa: Sialic acid quantification study was carried out using a kit representing a sensitive approach based on double enzymatic action (Prozyme; product code

GF57) to convert released sialic acid to pyruvic acid and subsequently to hydrogen peroxide, which is quantified by standard UV/fluorescence detection methods. The assay was carried out using standard protocol supplied with the kit. The amount of sialic acid was calculated by comparing from the absorbance of the standard curve obtained using sialic acid standard with known concentration. The possible total amount of N-glycans was calculated based on the average mass from the possible peaks by MALDI-MS.

Quantum dot-antibody conjugate: Carboxyl-functionalized quantum dot solution Qdot525 (Invitrogen) was conjugated with the C179 antibody using N-ethyl-N′-dimethylaminopropylcarbodiimide (EDC), by incubation in 10 mM borate buffer (pH 7.4), 2 hr at room temperature. Molar ratios in reaction were 1:40:1500 (Qdot535:C179:EDC). Conjugates were cleaned first through a 0.2 μm PES filter and later by 5 sequential rounds of centrifugal gel filtration (100,000 Da nominal cutoff), exchanging into 50 mM borate buffer (pH 8.2).

Mice Infection Model: Groups of mice (5/group) were infected with varying doses (50-250 pfu/mL) of PR8 virus (American Type Culture Collection). Bronchoalveolar lavage (in Hank's buffered salt solution) samples were collected from the mice 2 days post infection.

Statistical Analysis: Data from independent experimental sets were analyzed by t test, taking as input means and coefficients of variance produced by flow cytometry analytical software, according to the following formulas:

$${t}_{stat} = \frac{\vert {\overline{x}}_{a} - {\overline{x}}_{b} \vert}{\sqrt{\frac{{σ}_{a}^{2} + {σ}_{b}^{2}}{n}}}$$

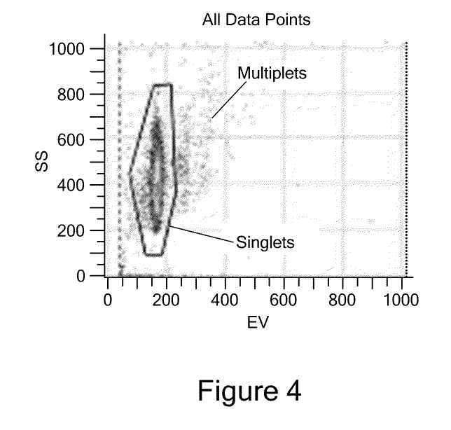

P values were calculated using the produced tₛₜₐₜ values using the GraphPad web applet (www.graphpad.com/quickcalcs/pvaluel.cfm, DF=n−1), and P<0.05 were considered statistically significant. In analyzing microparticles, care was taken to gate the singlet population in order to avoid multiplet bias (see FIG. 4).

### Results

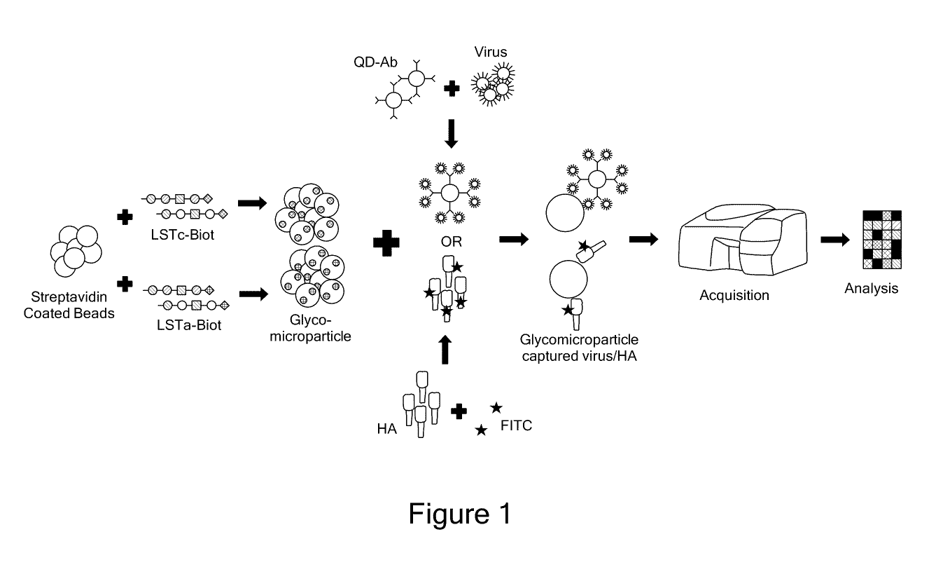

As described above, glycomicroparticles were synthesized using biotinylated glycans and streptavidin coated microparticles. Biotin/streptavidin binding was chosen as it was found to be rapid, stable, modular, and generated highly reproducible results. As a first step, two different glycans (LSTa and LSTc) representing distinct linkages and topologies were conjugated to biotin using a long chain LC-linker. The biotinylated glycans were purified by HPLC to remove excess biotin. In addition, two glycans (6′SLN-LN and 3′SLN-LN) with longer LC-LC-linker were obtained from the Consortium of Functional Glycomics in a biotinylated form. Purified biotinylated glycans were incubated with streptavidin-coated polystyrene microparticles with glycans present in large excess over particles. The resultant glycan coated particles were separated from the free sugars and used for binding studies (FIG. 1).

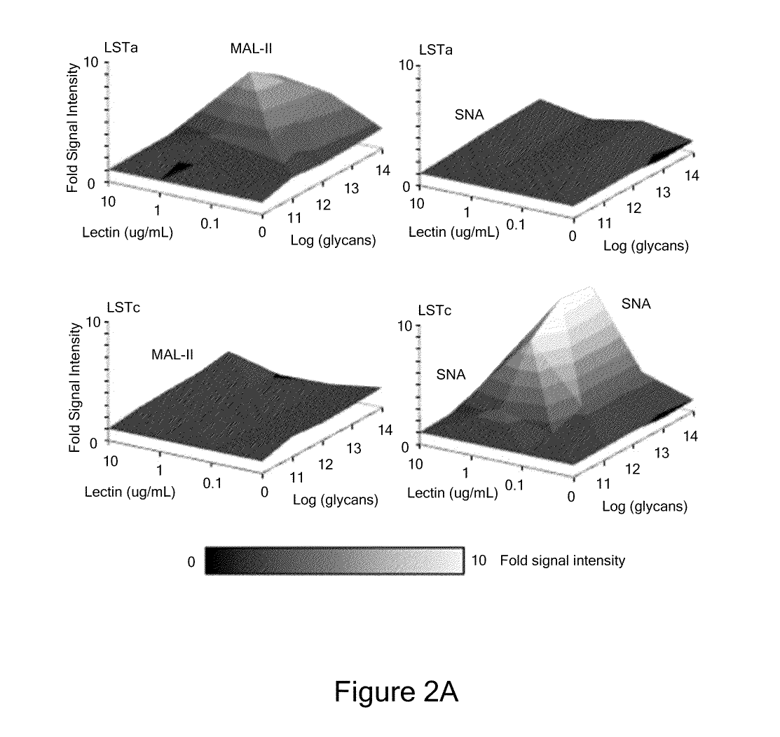

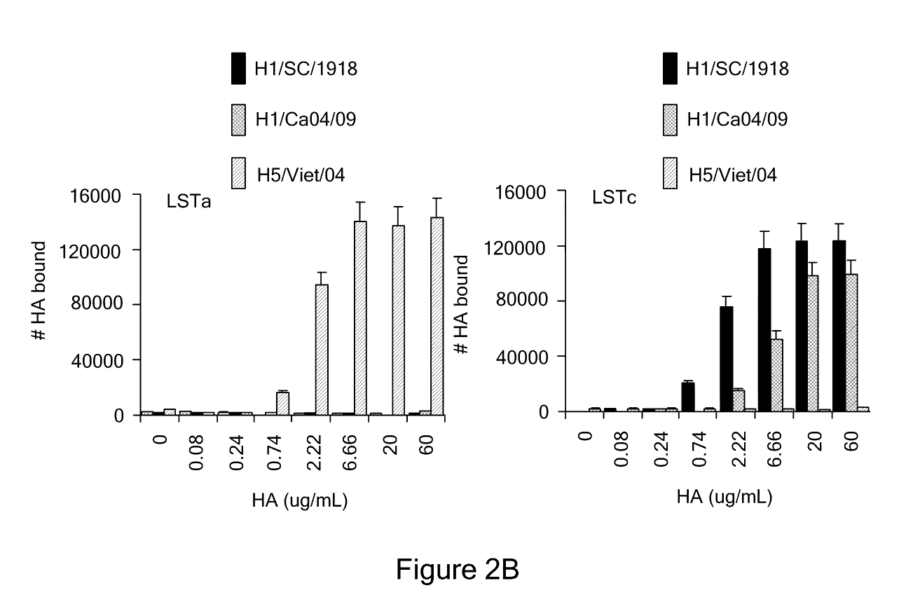

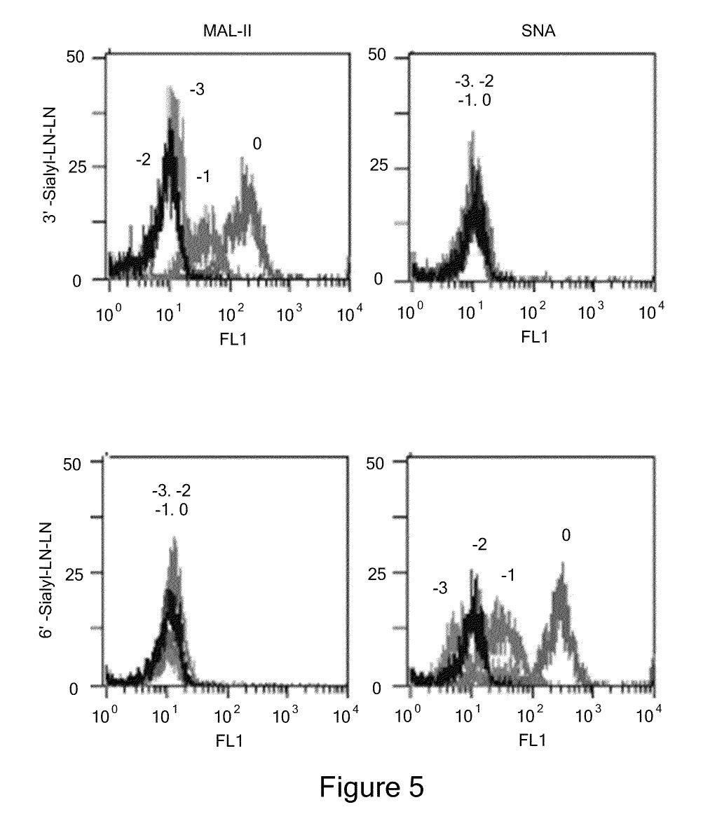

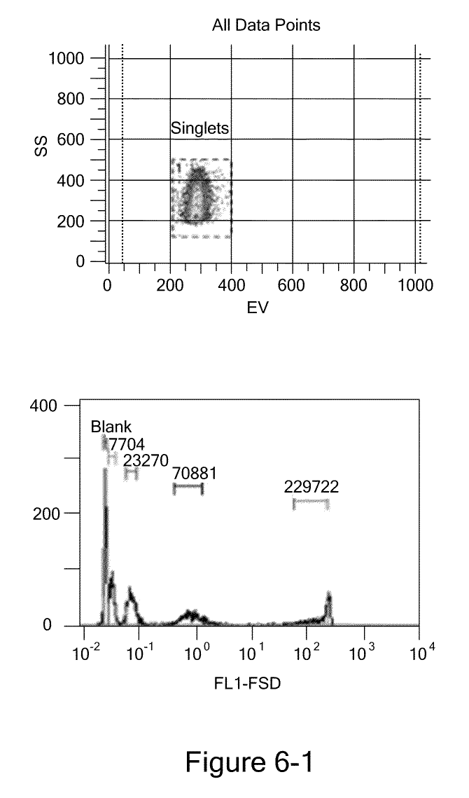

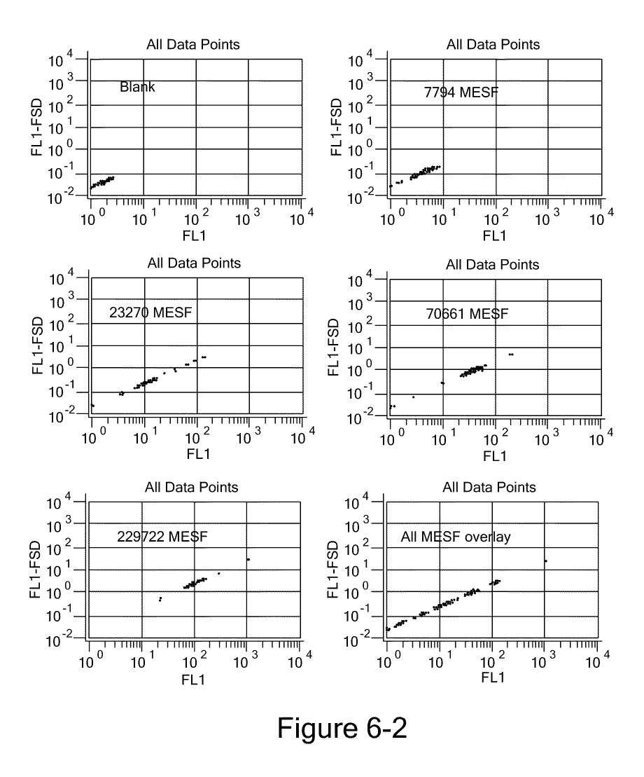

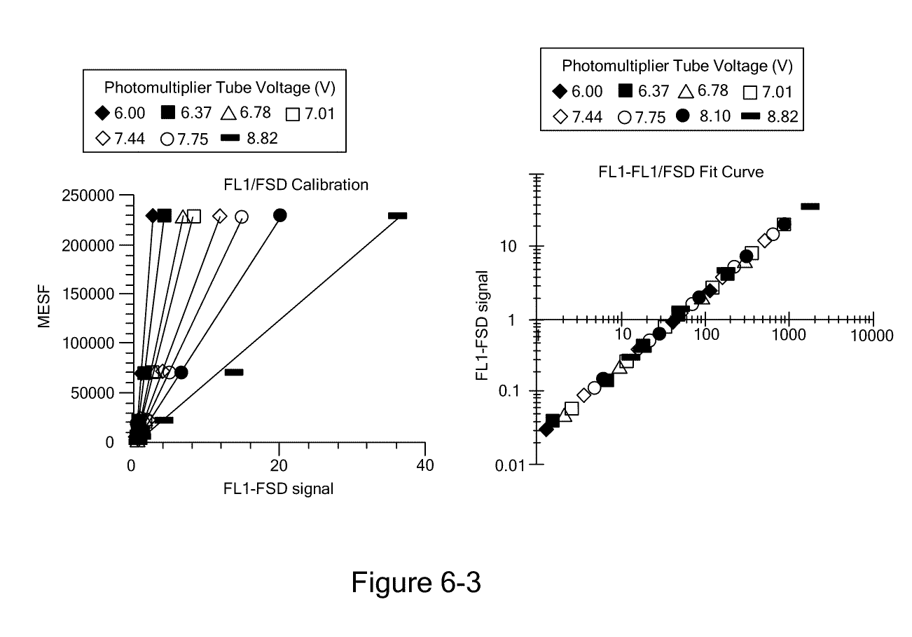

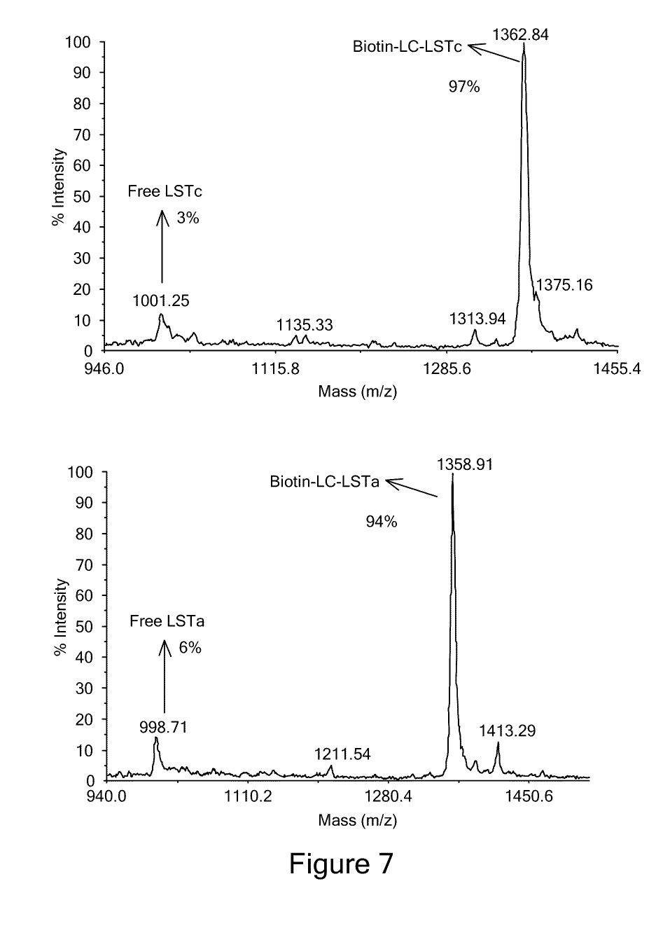

As a first step, these glycomicroparticles were probed with lectins of known specificity to confirm correct presentation of glycans. Sambacus nigra lectin (SNA), specific for Neu5Ac-α2-6Gal (e.g., Shibuya, N. et al. J Biol Chem 262, 1596-601 (1987)), present in LSTc/6′SLN-LN, and Maackia amurensis lectin (MAL-II), specific for Neu5Ac-α2-3Gal-131,4G1cNAc/Glc (Knibbs, R. N., Goldstein, I. J., Ratcliffe, R. M. & Shibuya, N. J Biol Chem 266, 83-8 (1991)), present in LSTa/3′SLN-LN, were labeled with FITC and used to probe the glycomicroparticles. SNA showed specific binding for LSTc and 6′SLN-LN and MAL-II showed specific binding to LSTa and 3′SLN-LN (FIG. 2A, FIG. 5).

Previous studies have reported that glycans adopt a distinct topology in the presence of HA (e.g., Chandrasekaran, A. et al. Nat Biotechnol 26, 107-13 (2008); Stevens, J. et al. J Mol Biol 355, 1143-55 (2006); Eisen, M. B., Sabesan, S., Skehel, J. J. & Wiley, D.C. Virology 232, 19-31 (1997); Ha, Y., Stevens, D. J., Skehel, J. J. & Wiley, D. C. Virology 309, 209-18 (2003)). The topology is a function of the linkage of the terminal sialic acid with the penultimate monosaccharide, the length of the oligosaccharide, and its binding mode with HA. HA from human adapted viruses show high affinity binding to ‘long’ (tetrasaccharide or longer) α2-6-linked glycans (e.g., Chandrasekaran, A. et al. Nat Biotechnol 26, 107-13 (2008)).

Using LSTc and LSTa, we probed the glycan specificity of a human-adapted HA from the 1918 Spanish flu pandemic (A/South Carolina/1/1918; SC18), the 2009 H1N1 pandemic (A/California/04/2009; Ca04), as well as an avian-adapted HA from a strain of H5N1, or ‘bird flu’ (A/Vietnam/1203/04; Viet04). With LSTa and LSTc coated particles, both SC18 and Ca04 showed a dose dependant binding to LSTc with no binding to LSTa (FIG. 2B). Additionally, the raw intensity data was converted to molecular equivalents of soluble fluorophore, enabling counting of the number of probing protein molecules and hence a quantitative comparison between binding affinity of different HAs. Consistent with previous findings on the planar glycan array platform, the binding affinity of Ca04 to long α2-6 linked glycan was lower than that of SC18 (e.g., Maines, T. R. et al. Science 325, 484-7 (2009)). Also consistent with previous findings the avian-adapted Viet04 HA showed no binding to LSTc and high affinity binding to LSTa (FIG. 2B).

While quantitative assessment of the HA-glycan interaction for isolated strains is important for assessing virus transmissibility, the assay platform can also be used to probe the glycan specificity of viruses present in biological samples. To demonstrate this, a two-step process was used.

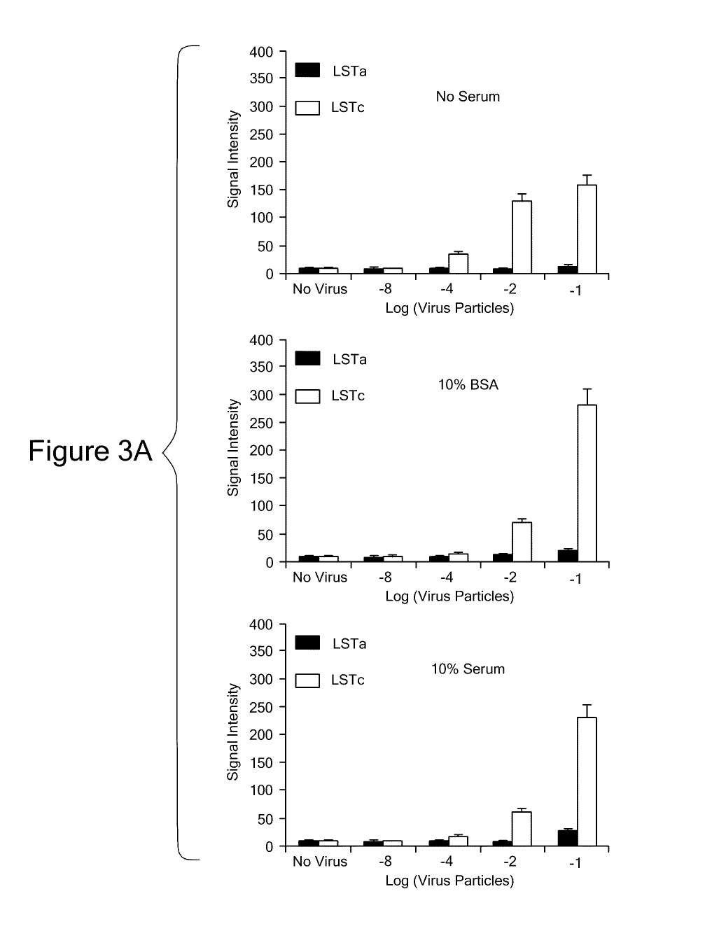

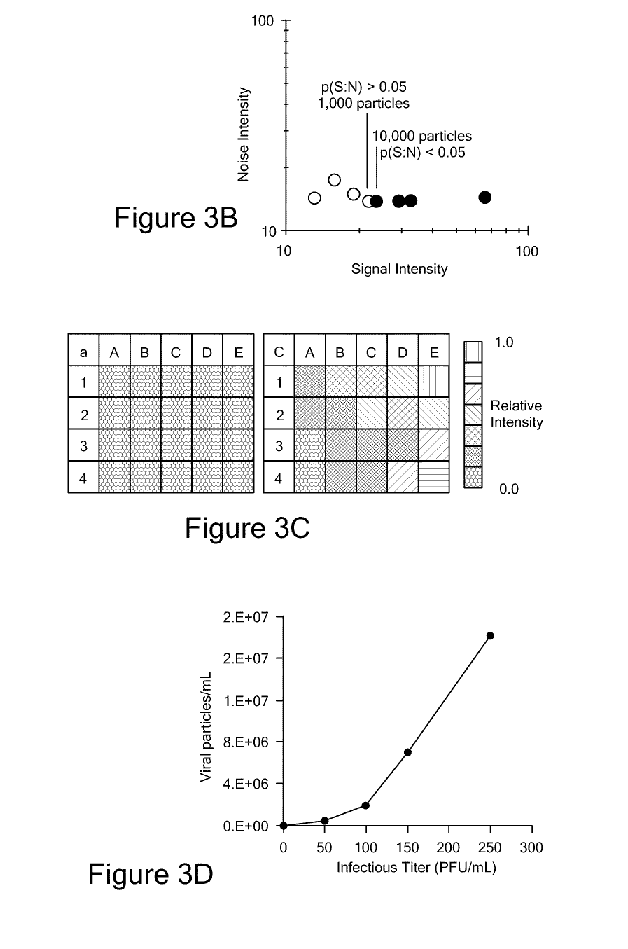

First, quantum dots (QD525) were coupled to a broad spectrum HA specific antibody (C179) (Okuno, Y., Isegawa, Y., Sasao, F. & Ueda, S. J Virol 67, 2552-8 (1993)) and the QD525-C179 conjugate was then used as a probe to capture A/New Caledoina/20/1999 (NC99) viral particles. The captured virus was then applied to the glycomicroparticles and the sample was analyzed by flow cytometry (Scheme 1). Microarray analysis revealed specific binding of NC99 to LSTc in agreement with NC99 being a human-adapted influenza strain (FIG. 3A). Moreover, the detection threshold of the assay was found to be approximately 10⁴ particles.

Next, the effect of sample matrix on detection was evaluated. The presence of 10% BSA or serum in the sample did not significantly interfere with the specificity or sensitivity of the assay system (FIG. 3B).

Finally, we employed QD525-C179 to probe biological samples from mice infected with various titers of A/Puerto Rico/8/34 H1N1 virus. Analysis of bronchoalveolar lavage fluid from mice infected with 50-250 pfu/mL enabled rapid and quantification of viral particles ranging from ˜3×10⁴ to ˜1.4×10⁷ (FIG. 3C, FIG. 3D).

Thus, the present Example demonstrates that we have developed a suspension array platform using glycomicroparticles for functional characterization of influenza hemagglutinin and virus. Using two distinct influenza receptor glycans we characterize HA and virus based on human adaptation. Those of ordinary skill in the art will appreciate that such an assay will provide an important addition to surveillance tools to study and categorize influenza strains.

### Equivalents

Those skilled in the art will recognize, or be able to ascertain using no more than routine experimentation, many equivalents to the specific embodiments of the invention described herein. The scope of the present invention is not intended to be limited to the above Description, but rather is as set forth in the following claims:

1. A particulate array comprising:
a first plurality of solid phase particles, each of which is associated with a first glycan population;
a second plurality of solid phase particles, each of which is associated with a second glycan population, different from the first glycan population.

2. The particulate array of claim 1, further comprising at least a third plurality of solid phase particles, each of which is associated with a third glycan population, different from each of the first and second glycan populations.

3. The particulate array of claim 1, wherein the first and second plurality of solid phase particles are detectably different from one another.

4. The particulate array of claim 2, wherein the first, second and at least third plurality of solid phase particles are detectably different from one another.

5. The particulate array of claim 3, wherein the pluralities of solid phase particles differ from one another based on a feature selected from the group consisting of particle size, particle color, and an optical signature or marker.

6-7. (canceled)

8. The particulate array of claim 1, wherein at least one of the plurality of solid phase particles is functionalized.

9. The particulate array of claim 1, wherein at least one of the plurality of solid phase particles is labeled.

10. The particulate array of claim 1, wherein the first glycan population comprises at least a first umbrella topology glycan.

11. The particulate array of claim 1, wherein the second glycan population comprises at least a first cone topology glycan.

12. The particulate array of claim 2, wherein the third glycan population comprises at least a second umbrella topology glycan.

13. The particulate array of claim 1, wherein at least one of the glycan populations comprises a glycan that is found in human epithelial tissues.

14. The particulate array of claim 13, wherein the human epithelial tissues are in the respiratory tract.

15. A method comprising steps of:
contacting a sample that contains a glycan binding agent with a particulate array comprising a first plurality of solid phase particles, each of which is associated with a first glycan population;
a second plurality of solid phase particles, each of which is associated with a second glycan population, different from the first glycan population; and
detecting binding to at least one of the pluralities of solid phase particles in the array.

16. (canceled)

17. The method of claim 15, wherein the sample is selected from the group consisting of an environmental sample, tissue of an organism, and bodily fluid of an organism.

18-19. (canceled)

20. The method of claim 17, wherein the organism is a bird or a mammal.

21. (canceled)

22. The method of claim 15, wherein the particulate array comprises glycans from a virus.

23. The method of claim 22, wherein the virus is influenza.

24-28. (canceled)

29. The method of claim 15, wherein the detecting comprises detecting a binding pattern.

30. The method of claim 29, wherein the detecting further comprises correlating the binding pattern with activity.

31. The method of claim 30, wherein correlating the binding pattern with activity determines a functional subtype.
